(19) United States
(12) Patent Application Publication
(10) Pub. No.: US 2011/0264588 A1
(43) Pub. Date: Oct. 27, 2011

(54) TRANSPORT RATING SYSTEM

(76) Inventors: Finn W. Jensen, Auckland (NZ); A. Wayne Almond, Copenhagen K (DK); Daniel Thomas Kinsley, Copenhagen (DK); Brent Michael Culp, Gentofte (DE)

(21) Appl. No.: 12/373,416

(22) PCT Filed: Jul. 9, 2007
(86) PCT No.: PCT/DK07/00348

§ 371 Date: May 20, 2011

Related U.S. Application Data
(60) Provisional application No. 60/819,606, filed on Jul. 10, 2006.

(51) Int. Cl. G06Q 20/00; G06Q 30/00

(52) U.S. Cl. 705/80; 705/400; 705/26.1

(57) ABSTRACT

Disclosed is a computer-implemented method of generating a service contract for a shipping product. The method comprises: receiving information indicative of a requested shipping product; verifying an availability of the requested shipping product by means of an electronic product catalogue; receiving a tariff corresponding to the requested shipping product from a tariff system; receiving cost information about a cost of the requested shipping product from the electronic catalogue system; providing a user interface for allowing an operator to determine a price proposal based on the received tariff and the received cost information; generating a service contract based on the determined price proposal.

### TECHNICAL FIELD

The present invention relates to a transport rating system and, in particular, to the pricing and contracting of shipping space.

### BACKGROUND

Container freight rates are subject to frequent changes, e.g. due to changing operating costs, availability of shipping space and/or container space. Furthermore, the freight rate offered to a given shipper or forwarder may depend on a large variety of parameters, such as type of cargo/commodity, destination and arrival locations, cargo volume/quantity, etc. On the other hand freight rates are subject to legislative regulations such as the US “Ocean shipping reform act of 1998” which requires that carriers develop individual electronic tariff systems available to the public for a reasonable access charge. The federal maritime commission is mandated to prescribe conditions for the accessibility and accuracy of these systems, and to review them periodically. Furthermore, The Ocean shipping reform act of 1998 provides an opportunity for shippers and carriers to enter into individual, confidential service contracts.

Transportation-related e-commerce business solutions have emerged during the past years on the liner shipping scene offering an array of automated, value-added service packages.

In particular, one emerging trend is the creation of a number of cargo-based, e-commerce portals which provide a centralized location for “one-stop shopping” for various participating carrier services. INTTRA and Global Transportation Network, two ocean carrier-backed Internet portals, focus on track-and-trace systems as a core capability.

As carriers often offer a large range of products, including many different routes, transport options, accessory products and services, it is generally desirable to provide an efficient system for determining a transport rate. In particular, tariffs of a tariff system are commercial entities and there is not always a one-to-one correspondence between a tariff and a shipping product. In particular, a large carrier may be able to offer millions or even billions of different shipping products, while a tariff system for practical reasons usually includes considerably fewer distinct tariffs.

### SUMMARY

According to one aspect, an embodiment of a computer-implemented method of generating a service contract for a shipping product comprises:
receiving information indicative of a requested shipping product;
verifying an availability of the requested shipping product by means of an electronic product catalogue;
receiving a tariff corresponding to the requested shipping product from a tariff system;
receiving cost information about a cost of the requested shipping product from the electronic product catalogue;
providing a user interface for allowing an operator to determine a price proposal based on the received tariff and the received cost information;
generating a service contract based on the determined price proposal.

Hence, a method is provided that facilitates the negotiation of service contracts between a carrier and a shipper or forwarder.

It is an advantage of embodiments of the method described herein that the price quotation may be performed as a ‘pricing by exception,’ i.e. as a quotation that is based on, but that may differ from, a base tariff.

Consequently, embodiments of the method described, herein ensure that a rate may be determined for every available shipping product, while ensuring that the generated rate reflects the prevailing market situation and that the generated rate is in accordance with the actual shipping costs related to the requested shipping product, thereby avoiding unintended losses.

Embodiments of the method described herein comprise storing general/base tariff rates and customer-specific service contracts, thereby allowing a user to access complete and accurate pricing information for any available shipping product. Examples of users include internal staff of the carrier and/or external customers, e.g. shippers or forwarders, that may have access to the rating system of the carrier, e.g. via an internet-based user-interface.

According to another aspect, an embodiment of a computer-implemented method for providing rate information about a shipping product comprises:
receiving a user identification of a user by a data processing system;
receiving information indicative of a shipping product;
automatically detecting whether the data processing system has stored a service contract associated to the user and covering the specified product;
responsive to the automatic detection, determining rate information for the shipping product from one of the detected service contract and a tariff provided by a tariff system.

According to yet another aspect, an embodiment of a computer-implemented method for managing a service contract associated to a plurality of shipping products comprises storing the service contract as a data structure indicative of a plurality of service contract lines, each service contract line having a status field attached to it indicative of a contractual status of the service contract line.

It is noted that the features of the methods described above and in the following may be implemented in software and carried out in a data processing system or other processing means caused by the execution of computer-executable instructions. Alternatively, the described features may be implemented by hardwired circuitry instead of software or in combination with software. The term “processing means” comprises any suitable general- or special-purpose programmable microprocessor, Digital Signal Processor (DSP), Application Specific Integrated Circuit (ASIC), Programmable Logic Array (PLA), Field Programmable Gate Array (FPGA), special purpose electronic circuits, etc., or a combination thereof.

Embodiments of the present invention can be implemented in different ways, including the methods described above and in the following, a suitably configured data processing system, and further product means, each yielding one or more of the benefits and advantages described in connection with the first-mentioned methods, and each having one or more embodiments corresponding to the embodiments described in connection with the first-mentioned methods and/or disclosed in the dependent claims.

In particular, the invention further relates to a data processing system configured to perform the steps of the method described above and in the following.

The data processing system may comprise a suitably programmed computer, e.g. a personal computer. In some embodiments the data processing system may comprise a plurality of computers, e.g. one or more server computers and one or more client computers suitably connected via a computer network.

In one embodiment, the data processing system comprises a central server computer and a number of client data processing systems. The client data processing systems and the server data processing system are configured to communicate with each other via a suitable communications link, e.g. a via a computer network, such as a local area network, a wide area network, an internet, or any other suitable communications network, or combination thereof.

According to another aspect, embodiments of a computer-implemented transport rating system comprise an electronic product catalogue for storing information specifying a plurality of shipping products, a tariff system for providing standard tariffs related to shipping products, and a service contract system for generating a customer-specific service contract for a shipping product.

In some embodiments, the service contract system includes:
a user interface operable to receive user input indicative of a requested shipping product;
a processing unit operable to verify an availability of the requested shipping product based on information received from the electronic product catalogue;
an interface to the tariff system operable to receive tariff information corresponding to the requested shipping product;
an interface to the electronic product catalogue operable to receive cost information about a cost of the requested shipping product from the electronic product catalogue;
a user interface operable to present a pricing structure determined from the received tariff information and the received cost information to a user and to receive a user input indicative of a change in the pricing structure resulting in a price proposal; wherein the processing unit is further operable to generate a service contract based on the determined price proposal.

According to yet another aspect, a computer-implemented system for providing rate information about a shipping product comprises:
an interface operable to receive a customer identification of a customer and information indicative of a shipping product;
a tariff system for storing a plurality of price structures for respective shipping products;
a service contract system for storing a plurality of service contracts, each service contract being associated to at least one specific customer and being related to a plurality of shipping products;
a processing unit operable to automatically detect whether the service contract system has stored therein a service contract associated to the received customer identification and related to the specified product; and wherein the processing unit is operable, responsive to the automatic detection, to determine rate information for the shipping product from one of the detected service contract and a tariff provided by the tariff system.

### BRIEF DESCRIPTION OF THE DRAWINGS

The invention will be explained more fully below in connection with embodiments and with reference to the drawings, in which:

FIG. 1 shows a schematic block diagram of an embodiment of a computer-implemented transport rating system.

FIG. 2 shows a functional schematic block diagram of an embodiment of a maritime automatic rating system.

FIG. 3 illustrates the maintenance and structure of service contracts.

FIG. 4 shows a functional block diagram of an example of a rating module.

FIG. 5 shows flow diagrams of a price retrieval process.

FIG. 6 illustrates an example of the structure and matching of routes.

FIG. 7 illustrates an example of a data structure for storing base rate tariff information.

FIG. 8 illustrates an example of a data structure for storing a shipping product.

FIG. 9 shows examples of user-interfaces of a tariff module.

FIG. 10 illustrates a data structure for storing rules.

### DETAILED DESCRIPTION

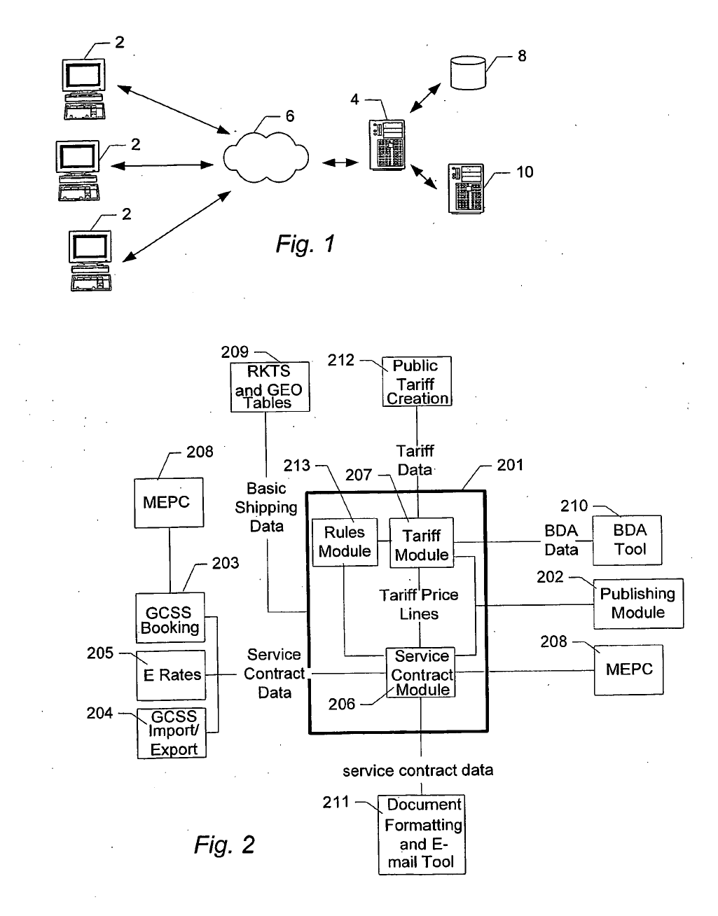

FIG. 1 is a block diagram of an example of a computer-implemented transport rating system. The system of FIG. 1 includes user or client systems 2. Each user system 2 may be implemented using a general-purpose computer executing a suitable computer program for carrying out the processes described herein. The user systems 2 may be personal computers owned by customers of a carrier such as shippers forwarders etc. User system 2 may also be a mobile device such as a mobile telephone, a handheld computer, a PDA, or other digital device with a display, controls, and a network or wireless connection.

A host system 4 is in communication with the user systems 2 through network 6. The host system 4 may be implemented using conventional servers and executes a computer program for carrying out the processes described herein. Host system 4 serves as a central location for base rate tariffs and customer service contracts.

The network 6 may be any type of known network including a local area network (LAN), wide area network (WAN), global network (e.g., Internet), intranet, etc. The user system 2 may be coupled to the host system 4 through multiple networks (e.g., intranet and Internet) so that not all user systems 2 are coupled to the host system 4 via the same network. One or both of the user systems 2 and the host system 4 may be connected to the network 6 in a wireless fashion and network 6 may be a wireless network. In one embodiment, the network 6 is the Internet and each user system 2 executes a user interface application (e.g., web browser) to contact the host system 4 through the network 6. Alternatively, a user system 2 may be implemented using a device programmed primarily for accessing network 6 such as a remote terminal.

The host system 4 may operate as a network server (often referred to as a web server) to communicate with the user systems 2. The host system 4 handles sending and receiving information to and from user systems 2 and can perform associated tasks. The host system 4 may also include a firewall to prevent unauthorized access to the host system 4 and enforce any limitations on authorized access. For instance, an administrator may have access to the entire system and have authority to modify portions of the system. The firewall may be implemented using conventional hardware and/or software as is known in the art.

The host system 4 also operates as an applications server. The host system 4 executes one or more computer programs to perform processes such as generating, viewing, manipulating, storing base rate tariffs and customer service contracts. The host system 4 may further interact with other systems 10, e.g. for receiving or outputting information related to shipping products and/or tariffs and/or customer service contracts. It is understood that separate servers may be used to implement the network server functions and the applications server functions. Alternatively, the network server, firewall and the applications server can be implemented by a single server executing computer programs to perform the requisite functions.

Storage device 8 may be implemented using a variety of devices for storing electronic information such as a database server, a file transfer protocol (FTP) server, or the like. It is understood that storage device 8 may be implemented using memory contained in host system 4 or may be a separate physical device. Storage device 8 has stored thereon a variety of information related to shipping products and/or tariffs and/or customer service contracts.

It is understood that the invention may be implemented by different computer-systems. For example, the entire process described herein may be executed on a single computer, e.g. a user computer or user computer system. In yet another embodiment, the system may be implemented as a distributed system, e.g. a peer-to-peer system, of a plurality of user computers.

Operation of the system will now be described with reference to FIGS. 2-10.

In one embodiment, the system of FIG. 1 is configured to execute a suite of application programs to store tariff and service contract prices for products and services of the container businesses of a carrier. For the purpose of the present description an embodiment of a suit of one or more software applications for implementing a maritime automatic rating system will be referred to as MARS. MARS enables automation of the application of rates to shipments. MARS is an infrastructure system delivering prices for requests from other software modules based on details from a shipping product database system—also referred to as an electronic product catalogue (MEPC), customer information, cargo characteristics, and optional value-added services. MARS is divided into three business applications: a Tariff module, a Rules module, and a Service Contract module. However, it will be appreciated that other functional divisions may be used.

FIG. 2 shows a functional schematic block diagram of an embodiment of a maritime automatic rating system.

The transport rating system, generally designated 200, includes a rating module 201. The rating module 201 includes a Tariff module 207, a service contract module 206 and a Rules module 213.

The tariff module 207 supports the creation and maintenance of tariffs for the available shipping products. The tariffs are stored in any suitable form, e.g. as a hierarchical tariff structure. It will be appreciated that each shipping product may have associated with it a plurality of parameters, not all of which are necessarily used for rate matching, thereby reducing the number of base rate tariffs that need to be maintained. Nevertheless in some embodiments, even some or all of the parameters not used for rate matching may be stored in the product database, thereby proving flexibility for possible future pricing of alternative or additional specific products. In particular, the Tariff module 207 maintains base rate tariffs and makes the base rate tariffs available for the service contract module 206, including basic freight rates, inland rates, surcharges, value-added services, and/or the like. The Tariff module stores base and inland tariff data in a structured way so that, when combined with the Service Contract and Retrieval modules, complete and accurate price information can be returned to a module that requests a price retrieval.

The service contract module 206 supports the process of negotiating service contracts between the carrier and a customer, storing and maintaining the negotiated process and terms of the negotiated service contract, and enables the application of the stored prices and terms throughout different phases of a given transport. In particular, the service contract module 206 maintains service contracts associated to respective customers, and provides rate information to other modules upon request.

While the tariff module includes a standard, general pricing structure, typically applicable as default or walk-in rates, the Service Contract module handles all negotiated, customer-specific deviations from rates generated by the Tariff module.

The Rules module 213 supports both the Tariff and Service Contract modules with text, data-rich, and calculable surcharge rules. The Rules module serves as a repository for rules of different types and for use in both the Tariff module and the Service Contract module. The Rules module 213 includes maintenance user-interfaces/screens for pure-text, calculable, and surcharge rules. The Rules module 213 includes the original versions of rules and many potential variations on the original rules. Tariffs and service contracts may then incorporate rules from the Rules module. In this sense, tariffs and service contracts in MARS do not have to construct their own surcharges or contract terms but may link to a single, global source of templates and then in some cases may customize text, values, or surcharge rates.

A service contract is an agreement between a carrier and a customer of the carrier, e.g. a shipper or a forwarder, about the rating/pricing for one or more shipping products. A service contract may be represented in a suitable data structure as will be described in greater detail below

Still referring to FIG. 2, the rating module 201 has interfaces to a number of modules:

A General Customer Service System (GCSS) Booking module 203 supplies the Service Contract Module 206 with a product identification provided from a maritime electronic product catalogue (MEPC) 208, as well as other pertinent transport data, such as information about the shipper, the recipient, information about possible reefer and/or hazardous cargo, etc. The Service Contract module 206 returns price lines to the GCSS Booking Module 203 for each identified pricing element and a total price for each product to be booked.

The GCSS Export/Import module 204 handles operational aspects of an actual shipment, such as preparing/issuing transport documents, preparation of manifests, and/or the like. To this end, the GCSS Export/Import module 204 has access to tariff and service contract price information from the service contract module 206.

The E-rates module 205 provides a user-interface, e.g. a web-based interface, allowing users, e.g. customers or their affiliates, to request freight rates and/or to book shipments via the Internet or other suitable computer network. Consequently, the E-Rates module 205 supplies the Service Contract module 206 with product information, e.g. an MEPC product, and other pertinent transport data, and the Service Contract module 206 returns price lines for each identified pricing element for each product that is requested to the E-rates module 205.

The GCSS Booking module 203, the GCSS Import/Export module 204 and the E-Rate module 205 each query the service contract module 206 for product prices. To this end each of the modules 203, 204, and 205 have an interface with the maritime electronic product catalogue (MEPC) 208 for receiving determining a specific product identifier. The corresponding module of the modules 203, 204, and 205 that performs a query thus forwards an MEPC product identifier along with other shipping related data to the service contract module. In response to a price query, the service contract module returns a service contract rate, an exceptional price, or a tariff price.

A publishing module 202 is configured to facilitate publishing of tariff rates and/or service contract rates. Tariffs may be published in any suitable form, e.g. in printed form or electronically. For example, the publishing module may make tariff rates available to users via a suitable web interface, and/or for publishing rates to official authorities such the US Federal Maritime Commission, etc.

An RKTS and Geo Tables module 209 maintains a number of reference tables that are used to validate code values for items such as commodities, conferences, freighting etc. For example, both rating system modules 206 and 207 use basic shipping data such as Harmonized system (HS) commodity codes or other forms of commodity codes. Furthermore, the RKTS and Geo Tables module 209 maintains location information, such as location information about ports and other geographical locations. Examples of information provided by the RKTS and Geo Tables module 209 include Commodity, Carrier Code, Locations, and Exchange Rates.

The Tariff module 207 further has an interface to a Business Defined Areas (BDA)=tool 210, adapted to create, maintain, and retrieve information about inland haulage zones, which are custom created geographical areas. The interface to the BDA module 210 thus allows addition and editing of inland zones from the Tariff module 207. A separate Pricing Area may be created in the BDA tool. The BDA module 210 may pass one or more of the following information to the Tariff module 207: Retrieve a part of the world (a BDA) as a simple selection, Retrieve a BDA for a specific location code (given by GCSS or E-Rates). Furthermore it may be possible to use the BDA Tool directly in order to e.g. create a new BDA within a previously retrieved part of the world, to break an existing BDA down into smaller units, thus creating new BDAs, to retrieve a BDA from a given location (given by GCSS or E-Rates), etc.

An output formatting module 211 formats documents generated by the rating module 201, in particular documents intended for external distribution e.g. distribution to customers, such as proposed service contracts. The output formatting module 211 passes the formatted information to an external communications system, e.g. for sending via E-mail, regular mail, a suitable data interface, a document repository, or via any other document communications channel.

A Public Tariff Creation module 212 maintains conference tariffs, i.e. tariffs managed by consortia of shipping lines. The rating module 201 receives the conference tariff information which is used for the creation of special conference tariffs in the rating system.

Furthermore, the service contract module 206 has an interface to the electronic product catalogue (MPEC) module 208. MPEG maintains cost information and optionally information about operating yield and/or other yields/margins for the products stored maintained by MPEG.

Access to the various modules and functions of the rating system may be subject to user authorisation, e.g. by associating a security profile to each user. The applications may require a specific login, e.g. password-based login and/or security may be based on a registration of the user's workstation/client station in a users table of a database maintained by the system. For example, each user may have assigned resources in an authorisation database table enabling access to specific screens.

Each of the modules described above may be a separate software application or a set of functions provided by one or a smaller number of software applications. It is understood that some or even all the above modules may be integrated into one system. Similarly, in some systems, not all the above modules may be present, or alternative and/or additional modules may be present.

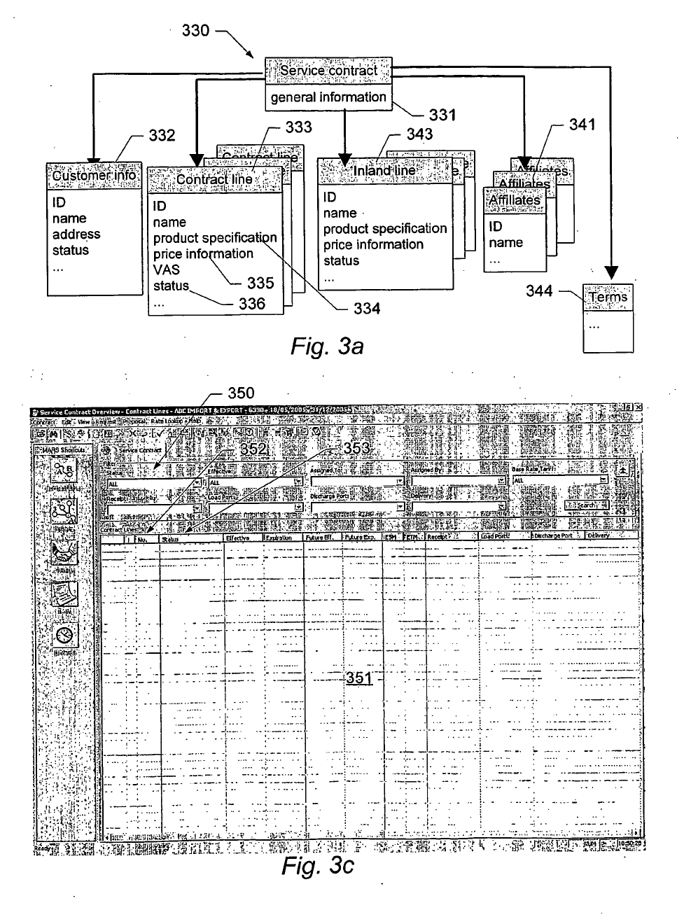

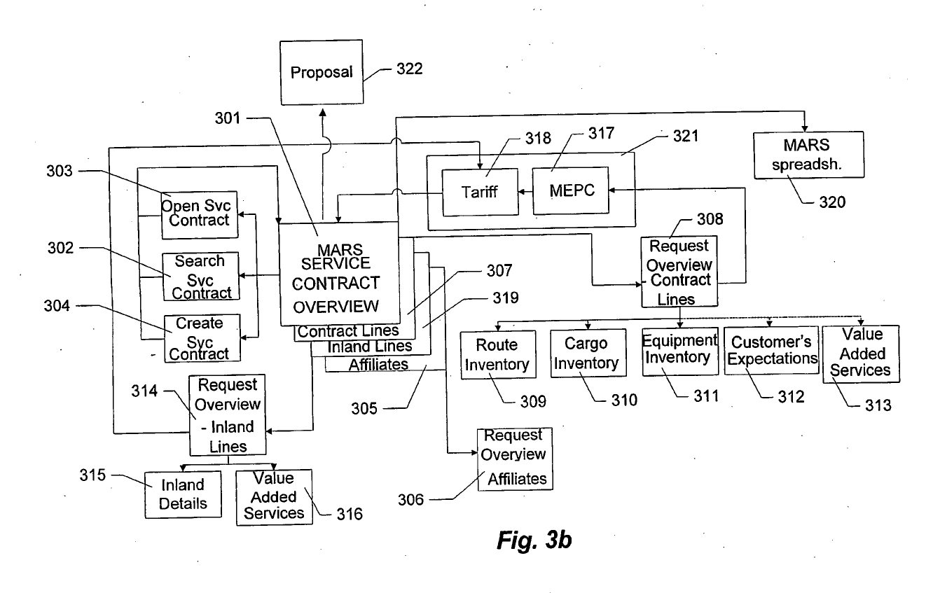

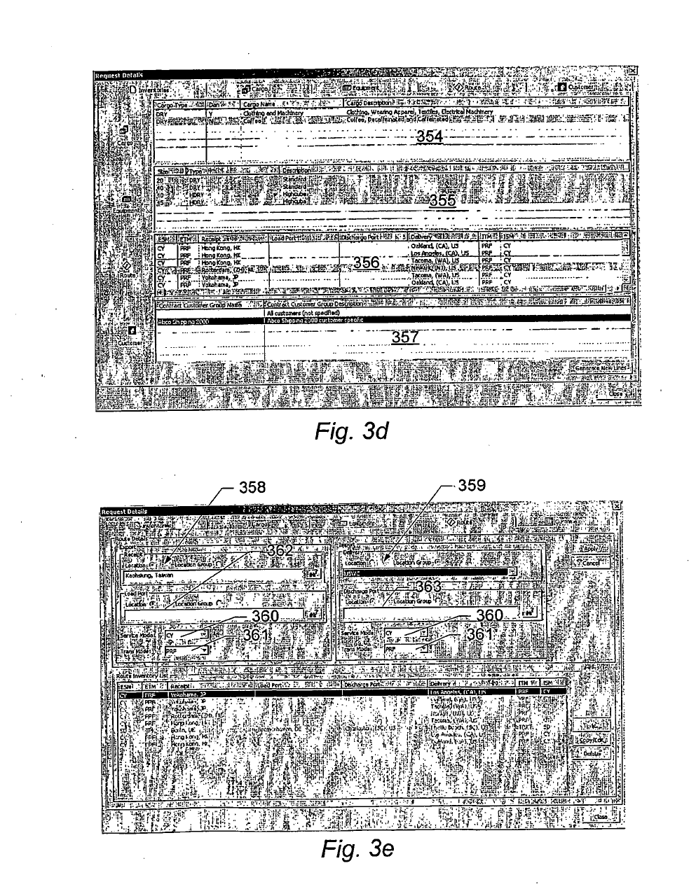

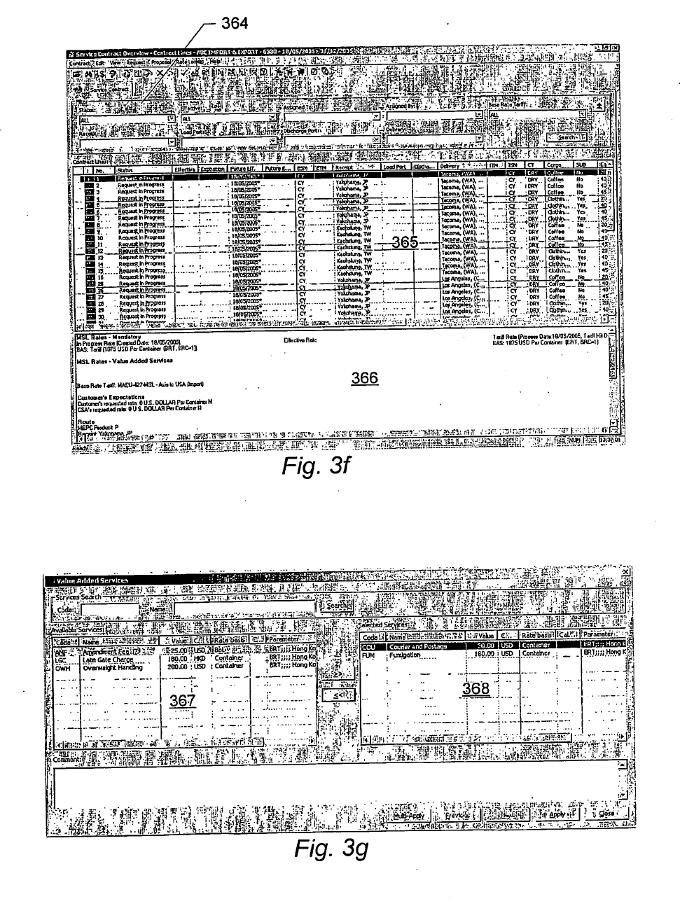

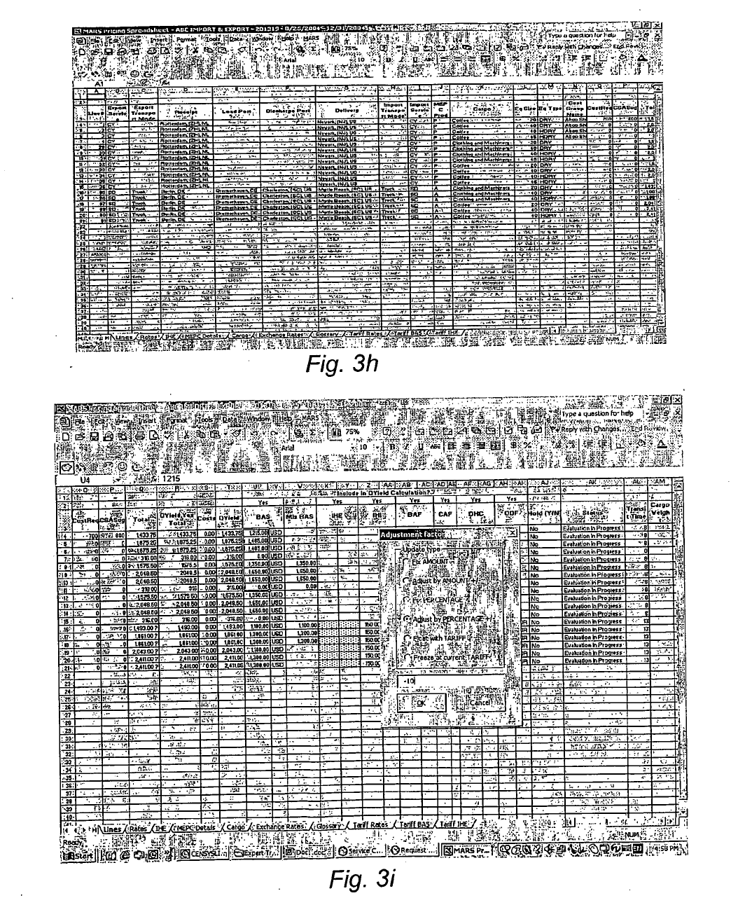

FIG. 3 illustrates the maintenance and structure of service contracts.

FIG. 3a shows an example of a data structure for storing a service contract. The data structure 330 includes general information 331, such as a service contract ID or number, a service contract name, a validity period, a status flag and/or the like. The status flag may indicate the overall status of the service contract in a predetermined workflow structure. The data structure 330 further includes customer information 332, such as customer ID, customer name, customer address and/or other contact information, etc. The service contract data structure further includes Information 341 about one or more affiliates, i.e. further customers other than the contract holder that are related to the contract.

The service contract further includes one or more contract line data structures 333 and inland line data structures 343. Each contract line 333 represents a price structure for a specified shipping product including ocean transport and includes shipping product information 334 specifying the shipping product and a corresponding rate/price 335. The shipping product specification may specify attributes such as equipment details, cargo details, route details, customer groups, rates, and/or the like. Similarly, each inland line includes information about inland transportation that may be combined with an ocean shipping product. The shipping products may be stored as a suitable data structure, e.g. as described in connection with FIG. 8, or it may be stored as a reference, e.g. a product code or key, referring to a stored structure of available products as described herein. Even though a service contract may include a single contract line, typical service contracts include a plurality of contract lines.

Each contract line further has a status attribute 336 associated with it, the status field being indicative of a contractual status of the contract line, thereby allowing maintaining a single service contract with a plurality of contract lines that each have their respective contractual status associated with. The status flag may indicate the status of the service contract line in a predetermined workflow structure. Consequently, when a customer wishes to include an additional product into the service contract, or alter the specifics and/or price of an existing contract line, such a change management can be performed as a workflow within the existing service contract. For example, the status attribute may assume one of a predetermined set of discrete values, each indicating a predetermined contractual status, such as “request”, “request in process”, “ready for evaluation”, “proposed to customer”, “agreed by customer”, “active”, and/or the like.

The service contract data structure 330 further includes contractual terms 344 specifying the contractual agreements related to the service contract.

FIG. 3b shows a functional block diagram illustrating functional blocks of the service contract module related to the creation and maintenance of service contracts. Each functional, block may have a corresponding user interface associated with it. Examples of user interfaces are in shown in FIGS. 3c-i.

The service contract overview block 301 is the main module of the service contract module and provides access to the remaining functions.

The search service contract block 302 provides functionality for searching for existing service contracts, e.g. by specifying a customer name, customer ID, a contract number, contract name, or contract reference, or the like. In response to a search, the search service contract block 302 presents a list of matching records, from which a user may select a given service contract to be opened.

The open service contract block 303 provides functionality for opening a service contract, e.g. by specifying a given service contract number.

The create service contract block 304 provides functionality for creating a new service contract, e.g. via a series of user interfaces for entering specifics of the service contract.

A service contract may have affiliates associated with it, and the Affiliates block 305 provides functionality for maintaining corresponding data structures. Affiliates may be regarded as the equivalent of ‘other’ contract holders. If another module requests rates for an affiliate's name, MARS will return applicable rates from contracts where a customer is a contract holder or an affiliate. Affiliates are usually legally affiliated with the Contract Holder, e.g. a subsidiary company. The Request Overview—Affiliates block 306 provides functionality for setting up a request to include Affiliates in a contract.

The contract lines block 307 provides functionality for viewing and manipulating (editing, changing, deleting; etc.) existing contract lines in all their statuses, and for creating new contract lines.

In particular, the request overview—contract lines block 308 provides functionality for processing newly created contract lines. Initially, a new contract line is assigned a status “Request”. The request overview—contract lines block 308 includes further blocks for specifying details of a contract line request:

The route inventory block 309 provides functionality for associating one or more routes with a contract line. A route is specified by at least a receipt and a delivery location. A route may further be specified by a load port and/or a discharge port. The route may further have associated an inland transport, e.g. preferred/default inland transport according to the electronic product catalogue or a specified inland transport. When the preffered inland transport is selected, the system determines the actual inland transport mode during subsequent processing of the request.

The cargo inventory block 310 provides functionality for associating one or more commodity types to a contract line, e.g. by specifying/selecting a corresponding commodity code. Furthermore, the cargo inventory block 310 provides functionality for specifying additional attributes such as surcharges for dangerous cargo, mixed load rates, and/or the like.

The equipment inventory block 311 provides functionality for associating one or more specific type(s) of equipment to a contract line, e.g. different sizes or types of containers.

The customer's expectations block 312 provides functionality for associating information about customer's expectations to a service contract or contract line, such as rate ideas, volume and competitive information. This feature may be used as a communication tool with the pricing authority.

The value added service (VAS) block 313 provides functionality for associating value added services to a contract line. The value added service specification is typically performed after processing the contract line.

The contract overview—inland lines block 319 provides functionality for viewing and manipulating (editing, changing, deleting, etc.) existing inland lines in all their statuses, and for creating new inland lines.

In particular, the request overview—inland lines block 314 provides functionality for processing newly created or amended inland lines. Initially, a new inland line is assigned a status “Request”. The request overview—inland lines block 314 includes further blocks for specifying details of a contract line request: An inland details block 315 provides functionality for specifying and associating with inland line detailed information. The value added service block 316 provides functionality for associating value added services to an inland line. The value added service specification is typically performed after processing the inland line.

When one or more contract and/or inland lines have been created using blocks 308 and 314 an are in status “request”, the processing block 321 provides functionality for processing the requested contract lines, preparing the contract line for subsequent pricing and resulting in a change in status for the process contract and/or inland lines. In the following the processing of lines will be described in the context of contract lines. It will be appreciated that the processing of inland lines may be performed analogously.

In one embodiment, there are three methods for processing contract lines: batch processing, online processing, and fast track processing: Batch processing lines allows the user to continue working in the MARS Service. Contract module while processing is in progress. Online processing involves processing the lines in the foreground, thus preventing the user from using the system until processing is complete. Fast Track processing facilitates the specification of Value Added Services in the contract and the pricing by a single user, i.e. in situations when the subsequent steps in the workflow are not reassigned to another user. Fast Track processing skips intermediate statuses “Request in Progress” and “Ready for Evaluation” and directly opens the Pricing Entry window for easy access to the pricing spreadsheet.

Processing a contract line by processing block 321 includes feeding the contract line details to the electronic product catalogue system MEPC (block 317) so as to verify that at least one product matching the request parameters exists. It also retrieves MEPC costs and transit times for display in the Pricing Spreadsheet.

Once a valid MEPC product is identified, the processing block queries the tariff module for an applicable Base Rate Tariff and Inland Tariff(s) (block 318) and delivers all tariff rates and surcharges to the service contract data structure for processing by the Service Contract overview block 301.

Successfully processed lines obtain the status ‘Request in Progress’ (unless Fast Track is used), i.e. they are ready for VAS selection.

There may be situations where lines are not successfully processed, e.g. if no MEPC product exists and/or if no valid tariff rate exists, in case of duplicate surcharges or overlapping tariffs. Contract lines which cannot be processed are identified in a user interface provided by the service contract overview block 301, thus allowing a manual or operator-assisted processing of the respective lines.

After the specification of value added services; if any, is completed., the user may change the status of the contract line from ‘Request in Progress’ to ‘Ready for Evaluation.’ When lines are in ‘Ready for Evaluation’, they are ready for pricing.

To this end, the pricing spreadsheet block 320 provides functionality for pricing the contract lines. This process may be initiated by the user for lines in status ‘Ready for Evaluation’. In response to a user input, the pricing spreadsheet block 320 generates a detailed spreadsheet. Alternatively to pricing, the user may choose to reject lines if the user does not wish to quote on this business.

In order to initiate the pricing, a user may highlight one or more lines to be priced in a user interface of the service contract overview block 301, and click on a corresponding button or icon. The process invokes a Pricing Entry window which displays a drop down menu with all Base Rate Tariffs that are applicable for the selected lines. The user picks one Base Rate Tariff from the dropdown, and initiates processing of the selected lines by the pricing spreadsheet block 320.

Lines may also be transferred to the Pricing Spreadsheat block 320 in a ‘read-only’ mode, so as to make them available for comparison or as a baseline/reference when pricing other lines.

The Pricing Spreadsheet block (PSS) 320 provides functionality for adjusting rates. It provides a detailed horizontal view of contract line details, rates, surcharges, value added services and their associated currencies. In addition, MEPC costs and transit times are displayed.

The Pricing Spreadsheet block (PSS) 320 further provides a variety of tools for facilitating the pricing process and decision-making, e.g. differently colored spreadsheet cells for indicating editable cells, edited cells, non-editable cells, etc. a umber of total/subtotal columns, and/or the like.

Additional worksheets may hold detailed information which may be helpful in making a pricing decision. These worksheets may include Tariff Rates, Tariff BAS (for multiple tariff base rates applicable for a cargo group), multi-level inlands and surcharges, commodity specific surcharges, MEPC Details, Cargo details, Exchange Rates, a Glossary, and/or the like.

Hence, a comprehensive tool is provided that allows users to enter adjusted rates or to otherwise amend the price structure, and that provides an immediate feedback as to the resulting prices and expected margins.

When the pricing process is completed, the user may invoke a proposal block 322 to create a new proposal of a service contract to a customer based on the priced contract lines, or to view all versions of existing proposals. The proposal block further provides functionality for sending a proposal to a customer, e.g. by printing a printed version, or by sending an electronically version via a computer network, e.g. as an e-mail attachment, or the like. A proposal may have associated with it a number of parameters, such as a proposal number, a proposal name, a Customer Acceptance Deadline, an FMC no for regulated contracts, etc. When a proposal is sent to the customer, the proposal is in status “Proposed”. The proposal statue can subsequently be changed to “rejected”, or “accepted”, or after possible amendments again to “proposed”.

FIGS. 3c-i show examples of user interfaces provided by the service contract module.

FIG. 3c shows an example of a user interface of the service contract overview—contract lines block for viewing existing contract lines and their respective statuses. The user interface provides a search/filter facility 350 for limiting the number of displayed contract lines. The user interface further includes a table 351 where each line represents a contract line and each column a contract line attribute, e.g. contract line number 352, status 353, etc.

FIG. 3d shows an example of another user interface of the service contract overview—contract lines block for viewing and editing details of a requested contract line, in particular cargo 354, equipment 355, route 356 and customer details 357 for customer-specific contract-lines.

FIG. 3e shows an example of another user interface of the service contract overview—contract lines block for viewing and editing route details of a requested contract line. The user interface includes elements for specifying receipt (358) and delivery (359) locations, import/export service (360) and transport (361) modes, load (362) and discharge (363) ports.

FIG. 3f shows another example of a user interface of the service contract overview—contract lines block for viewing existing contract lines that have been successfully processed. The user interface provides a search/filter facility 364 for limiting the number of displayed contract lines. The user interface further includes a table 365 where each line represents a contract line. The user interface further includes a detail panel 266 for viewing details of a selected/highlighted contract line.

FIG. 3g shows an example of a user interface of the value added service block for viewing requesting value added services for contract and/or inland lines. In particular, the user-interface provides a pick-list 367 of available value added services and a list 368 showing the currently selected value added services.

FIGS. 3h-i show an example of a user interface of the pricing spreadsheet block.

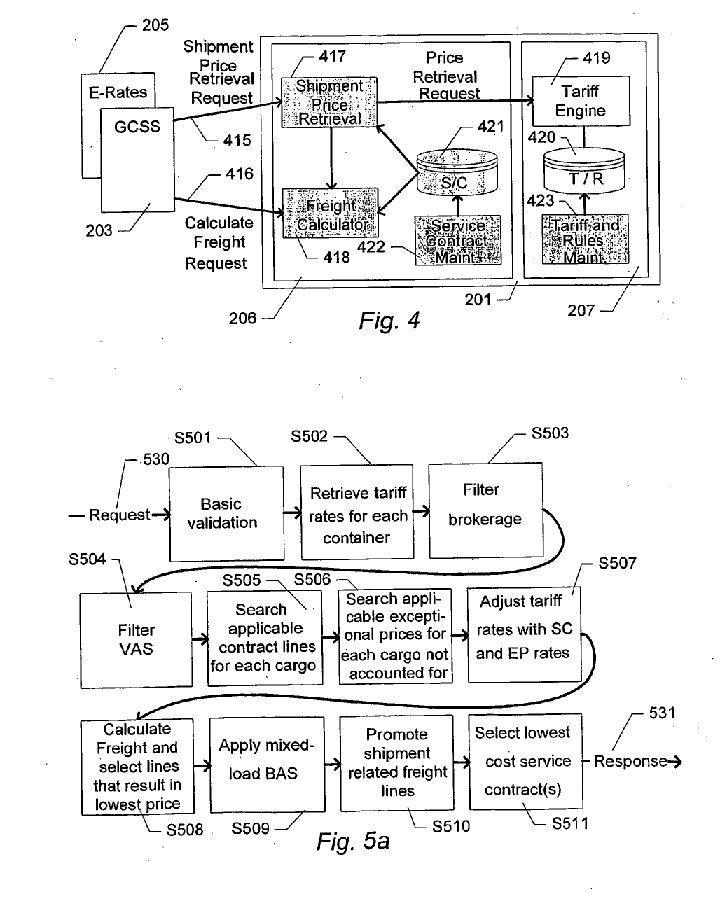

FIG. 4 shows a functional block diagram of an example of a rating module. The rating module 201 includes a service contract module 206 and a tariff module 207 as described above. Each of the GCSS Booking module 203 and the E-Rate module 205 may send a request for shipment price retrieval 415 or a request for a freight calculation 416 to the service contract module 206. For example, based on a customer identifier, GCSS may determine whether a rate/price for a specific product exists for that customer or whether a freight calculation needs to be performed. Accordingly, GCSS may either perform a request for a price retrieval of a previously calculated price or a request for freight calculation. To this end, the service contract module includes two interface applications—Retrieval 417 and Calculator 418—which hold business logic and handle the input from and output to GCSS and other systems. The shipment price retrieval module 417 is configured to process a request for a shipment price 415 and the Freight Calculator module 418 is configured to perform freight calculation.

The Shipment price retrieval module 417 has an interface to a tariff engine 419 of the tariff module 207 for receiving price information based on a tariff. To this end, the tariff engine 419 has access to a tariff and rules database 420. The shipment price retrieval module 417 has further access to a service contract database 421 of the service contract module 206 for receiving reference data and data about service contracts when the received shipment price request is related to a customer that has one or more service, contracts associated with it. The shipment price retrieval module 417 has further access to the Freight calculator 418.

The Freight calculator 418 has also access to the service contract database 421 for receiving reference data and exchange rates.

Finally, the service contract module 206 has a service contract maintenance module 422 for maintaining the service contracts stored in the service contract database 421, and the tariff module has a corresponding tariff and rules maintenance module 423 for maintaining the tariffs and rules stored in the tariff and rules database 420. The maintenance modules 422 and 423 provide user interfaces for editing/manipulating entries in the respective databases as well as user interfaces for creating new entries.

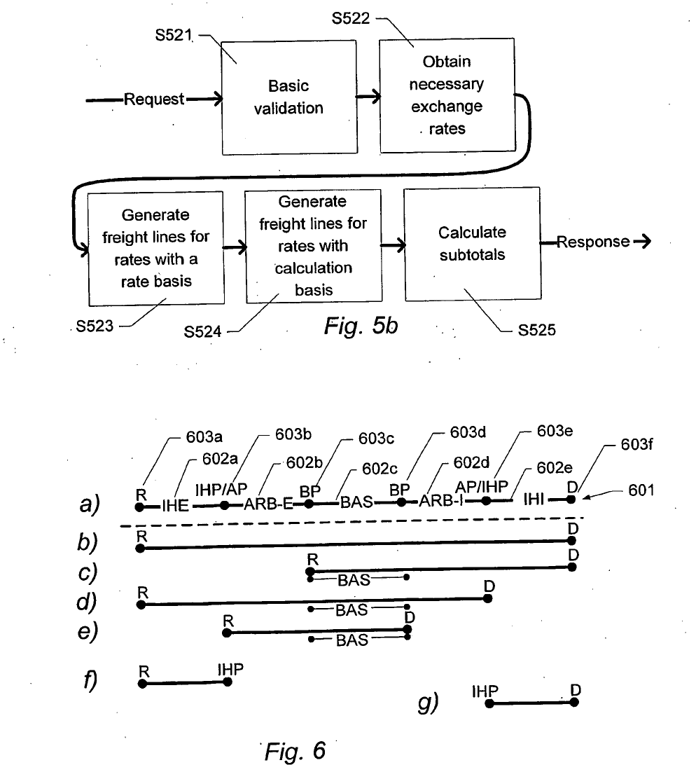

An example of a price retrieval/calculation process performed by the service contract module will now be described with reference to FIG. 5 and with continued reference to FIGS. 2 and 4.

Initially, the process receives a request 530 for a price for a shipment. The request includes information about a shipping product and information about the requesting customer. For example, the request may include at least some of the following information: customer, departure/receipt location, arrival location/location of delivery, MEPC product identification, type of cargo/commodity, amount/volume of the commodity, type of container, number of containers, mixed commodity information, additional routing information, operator information, service mode information, desired value-added services, etc.

An example of a request may include the following data:

SCV-Id (=customer ID)
SC-Number (optional)
Operator/Type
Service Mode (e.g. CY, SD, etc.)
Price Retrieval Date
MEPC product information
Container type 1:
Number of identical: 1
Size: 40′
Type: REEF
Dangerous characteristics/codes
Commodity information:
Commodity A: Type: REEF, Ratio: 50%, Weight: 2 tons,
Measure: 3 m³.
Commodity B: Type: REEF, Ratio: 50%, Weight: 2 tons,
Measure: 3 m³.
Container type 2:
Number of identical: 2
Size: 20′
Type: REEF
Dangerous characteristics/codes
Commodity information:
Commodity C: Type: REEF, Ratio: 100%, Weight: 6
tons, Measure: 5 m³.

In an initial step S501, the shipment price retrieval module 417 validates the request. The validation may include a verification for syntax errors, a service contract validation, and a customer validation, and/or a verification as to whether the specified shipping product is available, e.g. whether the carrier services the specified locations/ports, whether a specified routing is available with the specified types of containers, etc. For example, not all routes may allow refrigerated containers, all containers of all sizes, etc. Hence, the validation may include a request to the MEPC module 208. Upon successful verification, the process continues at step S502; otherwise the process terminates, e.g. by returning information as to why the validation has failed.

In step S502, the shipment price retrieval module 417 retrieves tariff rates for each container/equipment from the tariff database 420 via the tariff engine 419. The tariff engine associates the commodity and base rate specific rates to each cargo and further returns inland haulage transport modes. The tariff engine may return one or more error flags, e.g. if the commodity is insufficiently specified, when there are no rates for all commodities, when the total weight is outside inland rate weight intervals, or the like. The error may be an equipment level error, i.e. one or more containers are not priced, or a top-level error, i.e. the whole shipment is not priced.

An example of an association of commodities and tariff rates may be as follows, for a container with two commodities having respective commodity codes HS410110 and HS401519.

In one example, the tariff engine returns the following data:

Common rates:
IHE 100 USD/Container
CCL 50 USD/Container, HS40
CCL 75 USD/Container, HS41
Base Rate Classes:
BRC11: HS410110
BRC12: HS401519
BRC11 specific rates:
BAS 800 USD/Container
FUM 100 USD/Container
BRC12 specific rates:

BAS 100 USD/Ton
FUM 15 USD/Ton

where, the codes BAS, IHE, CCL, FUM, etc. represent respective charges, e.g. IHE=Inland Haulage, BAS=base rate, etc.

In this specific example, the shipment price retrieval module may then identify the following applicable price lines for each commodity:

HS410110:
IHE 100 USD/Container
CCL 75 USD/Container, HS41
BAS 800 USD/Container
FUM 100 USD/Container
HS401519

IHE 100 USD/Container
CCL 50 USD/Container, HS40
BAS 100 USD/Ton
FUM 15 USD/Ton

In step S503, the process performs a “Filter brokerage” process. This process determines whether Inland haulage by an inward or outward forwarder results in inward or outward brokerage charges, respectively. For example, if the request has specified an inland forwarder, the process determines whether the inland forwarder is part of the same entity as the customer (e.g. based on stored customer information). If this is the case, no charges apply, and the inland forwarding is filtered from the request for the purpose of freight calculation.

The caller may specify a list of requested value-added services. In step S504, the process performs a Value-added service filter, so as to remove possible VAS charges specified in a tariff for services actually not requested in the request.

In step S505; the shipment price retrieval process searches, in the service contract database 421 for a service contract applicable to the corresponding customer associated to the request. If no customer was specified in the request or if no service contract exists for the customer, the process continues at step S506. If one or more applicable service contracts are identified, the process performs the following steps:
The process identifies service contracts that are valid at the price calculation date. This verification may include one or more of the following: a verification that the customer is the contract holder or an affiliate, that the contract is effective, that the operator and type match, and/or that the service contract number matches.
The process identifies all applicable contract lines, i.e. contract lines that are valid and match the specified product. This search may test one or more of the following conditions: The contract line is valid, the equipment matches (size/type), the cargo matches (type and commodity), the customer is in the corresponding customer group, if the contract line is customer specific, the route matches. The verification as to whether the route matches may include a verification of one or more general rules, such as that the service modes and transport modes match and/or that the main ports of the MEPC product match or are unspecified in the contract line. In general, a contract line may be a complete or a partial route match with possible extension on one or both sides, as will be is illustrated in more detail below with reference to FIG. 6
The process identifies the most specific match if multiple lines match within a service contract. For example, a non-extended match may be more specific than an extended match, a customer specific match may be more specific than a general match, a match that is extended in one side may be more specific than a match that is extended in both sides, a match that is extended with an inland line may be more specific than a match that is extended with tariff, a main port match may be more specific than a match with unspecified main port.

If a container contains multiple commodities they are priced independently. The prices are later pro-rated with respect to the ratio of each commodity in the container. The search for contract lines may return an error or a warning, e.g. if the commodity is not sufficiently specified, if there is a main port mismatch for all contract lines, or if the commodities are only partly covered by the service contract.

In step S506, the process searches applicable exceptional prices for each cargo not accounted for by the service contract.

In step S507, the process adjusts the retrieved tariff rates by the rates associated with any applicable service contract and/or exceptional prices identified. To this end, the process searches for matching rates in the identified applicable contract lines, inland lines and exceptional prices. In one embodiment, a rate is determined as matching when it relates to the same freight type, the same BRC (except from BAS), when the weight is covered by the corresponding weight interval (in case of export/import inland haulage), when it relates to the same commodity, dangerous characteristics/codes, locations, and tariff type (in case of VAS/Surcharges).

If a matching service contract rate is found, the process uses the contract rate, but calculates the validity of the rate as the smallest intersection between the tariff rate, the service contract, affiliate, contract line, and inland line validities.

If float with tariff: The process validates that the calculation basis, currency; and rate basis match. If this is not the case, the process uses the tariff rate. The process adjusts the value, if the tariff value is outside the min/max specified on the contract rate element.

The searches of the previous steps may result in more than one alternative shipping products, e.g. in situations where the price request allows for more than one specific shipping product, e.g. different routes between a departure port and an arrival port, different ports for serving a particular inland location, and/or the like. Accordingly, in step S508 the process calculates the freight and selects the service contract line(s) that result(s) in the lowest total price.

The process invokes the freight calculator module 418 for each container/commodity and with all price alternatives (i.e. for all applicable contract lines). The freight calculator returns freight lines as well as a subtotal for each commodity. For each service contract where multiple equally applicable contract lines were identified, the process selects the line that results in the lowest price (i.e. the lowest price alternative subtotal)

In step S509, the process applies mixed-load BAS, in cases of containers with two or more commodities, when contract lines have two or more cargo subgroups in the cargo details, and when the container contains commodities from both subgroups. In this case, the process determines a mix load BAS instead of a straight load BAS, and the process performs a recalculation of the affected containers by calling the freight calculator module.

In step S510, the process promotes shipment related freight lines.

Finally, in step S511, the process selects the lowest cost service contract(s) and returns the corresponding price information. In particular, if the process has identified more than one applicable service contract, the process calculates the total freight for each service contract as the sum of the prices for those containers that did not cause errors plus shipment related rates. The process then selects the lowest cost service contract. If more than one service contract result in an identical price, then the process returns all service contracts with identical price.

An example of a response 531 from the shipment price retrieval process for the above input example may look as follows:

ServiceContract-number: 23486
Grand Total: 1000 USD
Exchange Rate Date: 04 Jan. 2005
Freight Lines
Container type 1:
CL/IL-number: 1/-
Transport Mode: TRK/TRK
Tariffs: NAMEUR, USWC, DKIMP
Freight Lines
CL/IL-number: 2/-
Transport Mode: TRK/TRK
Tariffs: NAMEUR, USWC, DKIMP
Freight Lines
Container type 2:
CL/IL-number: 3/1
Transport Mode: TRK/TRK
Tariffs: NAMEUR, USWC, DKIMP
Freight Lines

The response may include a plurality of freight lines. An example of a freight line may include the following fields: freight type, value, VAS (Y/N), tariff type (e.g. BRT), rate basis (container/weight), calculation basis, service contract rate (Y/N), amount, sum amount, currency, valid from, valid to; locations, commodity code, dangerous code, BRC.

FIG. 5b shows a more detailed flow diagram of the process performed by the freight calculator module.

The freight calculator module receives a request for freight calculation. Typically, the freight calculator is called with a list of “price alternatives”. When called by the shipment price retrieval module, a “price alternative” may be a specific Container/Commodity/ContractLine combination. When called by another module, e.g. GCSS or E-rate, a “price alternative” may be a specific Container/Commodity combination.

In initial step S521, the process performs a validation of the input request, e.g. for syntax errors, circular dependencies and/or inconsistencies.

In step S522, the process obtains the necessary exchange rates. The process determines which currency to use, e.g. the currency specified in the request, if any, or the tariff currency according to the tariff type of the corresponding rate element. The process then determines and retrieves all needed exchange rates for the relevant date.

In step S523, the process generates freight lines for rates with a rate basis that can be retrieved via a price retrieval request.

In step S524, the process generates freight lines for rates with calculation basis that require calculation based on a Freight calculation request.

In step S525, the process calculates subtotals from the generated freight lines.

FIG. 6 illustrates the structure and matching of routes. A transport route 601 comprises a series of transport legs 602a-e connecting a series of locations 603a-f. FIG. 6a illustrates an example of a transport route 601 between a departure/receipt inland location 603a where the cargo is received by the transport operator and an arrival/delivery inland (or so-called storedoor) location 603f. The transport route further includes respective so-called minor or arbitrary ports 603b and 603e and base ports 603c and 603d. Furthermore, the route may be divided into an export side corresponding to locations 603a-c and an import side corresponding to locations 603d-f. Hence, on the export side, the transport leg 602a between the storedore receipt location 603a and the arbitrary port 603b corresponds to inland haulage on the export side; the transport leg 602b between arbitrary export port 603b and base port 603c is an ocean transport, e.g. a feeder route; the transport leg 602c between base ports 603c and 603d is an ocean transport having a base rate associated with it. On the import side, there is a corresponding series of ocean and inland haulage legs. It will be appreciated that some routes may have fewer or more intermediate locations on one or both of the import and export side of the route. For example, a route may start at a base port and end at an arbitrary port on the import side, another route may start at an inland receipt location from where the inland haulage leg directly leads to a base port, etc. Furthermore, a transport leg between two base ports may physically be a transport via one or more via ports. Hence, it will further be appreciated that, for a given set of inland locations and/or base ports, there may be a plurality of possible routes connecting these locations, e.g. via different feeder routes from different arbitrary ports and/or because there may be different lines (e.g. via different via ports) connecting the selected base ports.

FIGS. 6b-g illustrate a number of examples of perfect and partial/extendable matches between routes defined in a contract line and an actual pricing product. For the purpose of the examples of FIGS. 6b-g, it is assumed that the route of FIG. 6a is a pricing product for which the system has determined a tariff where the system is searching for matching contract lines (CLs).

FIG. 6b illustrates a situation, where the route specified in the contract line has a complete overlap with the pricing product, i.e. in particular has the same receipt and delivery locations.

FIGS. 6c-e illustrates examples of base and/or arbitrary port matches, where the contract line specifies the same base ports as the route of the pricing product and where the contract line allows for an extension of the route on the export side and/or on the import side.

In the example of FIG. 6c, the receipt location of the service contract route corresponds to the base port 603c and the delivery location corresponds to the delivery location 603f (base port match, extendable on export side).

In the example of FIG. 6d, the receipt location of the service contract route corresponds to the receipt location 603a, while the delivery location corresponds to the arbitrary port 603e (arbitrary port match, extendable on import side).

In the example of FIG. 6e, the receipt location of the service contract route corresponds to arbitrary port 603b, while the delivery location corresponds to the base port 603d (base/arbitrary port match, extendable on both sides).

FIGS. 6f and 6g illustrate possible extensions with inland lines. FIG. 6f illustrates a possible inland extension on the export side that can be used in connection with the routes of FIGS. 6c and e. FIG. 6g illustrates a possible inland extension on the import side that can be used in connection with the routes of FIGS. 6d and e. Such extensions may be used when they are valid and relate to the same service contract and base rate tariff as the contract line with which they are combined, and when the respective other attributes to which they relate match, e.g. equipment (size, type), cargo (type), and weight match (total container weight).

The matching of routes may be illustrated by the following example:

For the purpose of this example it is assumed that an MEPC Product, i.e. a product specified in the electronic product catalogue, is defined as:

USBOS=trk=>USNWK=mvs=>DEBRV=trk=>DKCPH

i.e. the receipt location is USBOS, the delivery location is DKCPH, the load/discharge main ports are USNWK and DEBRV. The inland transport is by truck (trk) while the ocean transport is performed by a specified operator (msv).

It is further assumed that the product to be priced is:

USBOS=trk=>USNWK=>DEBRV=trk=>DKCPH

### With Service Mode: SD/SD (=Storedoor to Storedoor)

A contract line matches the route without extending if the following conditions are fulfilled:
The Receipt and Delivery locations are=USBOS and DKCPH
The load main port is USBOS or unspecified
The discharge main port is DKCPH or unspecified
The transport and service modes on import/export sides are TRK/TRK+SD/SD.

A contract line matches the route by extending the export leg e.g. if:
The receipt and delivery locations are USNWK and DKCPH
The load main port is USBOS or unspecified
The discharge main port is DKCPH or unspecified
No export inland haulage is specified and the import transport mode is TRK.
Service modes=CY/SD (i.e. container yard to storedore)
BAS origin=USBOS

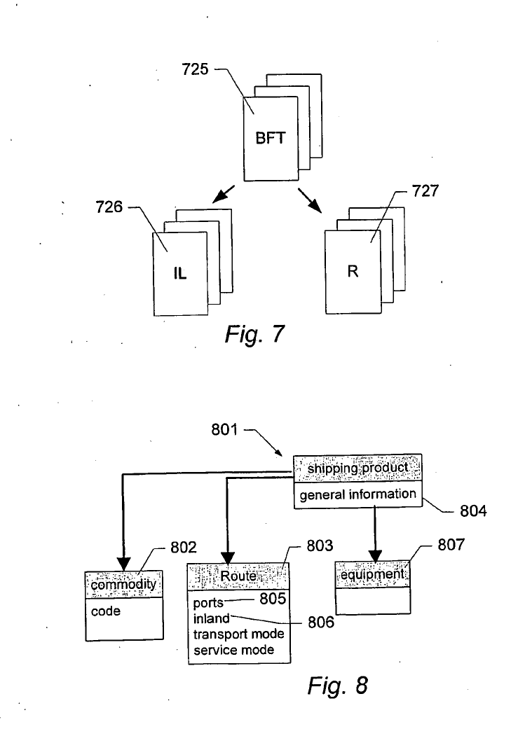

FIG. 7 illustrates and example of a data structure for storing base rate tariff information. The data structure includes base rate tariffs (BRT) 725, inland tariffs 726, and rules and surcharges 727.

A Base Rate Tariff (BRT) 725 may be viewed as a price list for transports performed between predefined base ports. BRT's are differentiated from one another by their scopes, the list of countries and base and other pricing ports between which base rates are defined. Base Rates may cover pure ocean transports and/or ocean-land combined moves, depending on the assignment of base ports. A BRT includes base rates and may further include links to text and surcharge rules 727 and to inland tariffs 726.

FIG. 8 illustrates an example of a data structure for storing a shipping product. The data structure 801 has associated with it cargo/commodity information 802 about the cargo/commodity to be transported, route information 803 about the shipping route, equipment information 807, and possible additional information 804 about additional services, constraints, and/or the like.

The cargo information may 802 be defined in any suitable manner, e.g. by means of predetermined commodity codes, e.g. a hierarchical structure of such codes, or the like.

The route information 803 includes a departure or receipt/pick-up location where the cargo is taken over and an arrival/delivery location where the cargo is delivered. In one embodiment, the receipt and delivery locations may be respective ports or inland locations—so-called storedoor locations. Consequently, the route information may include a departure port and an arrival port plus inland haulage transportation between the respective ports and inland locations for cargo pick-up and/or delivery.

The port information may further be structured by distinguishing so-called base ports and arbitrary ports. Accordingly, the route information 803 may include information about arrival and departure ports 805, e.g. base ports and/or other ports, as well as optional inland transport information 806.

The equipment information 807 may include the size and/or type of container(s) to be used, and or the like.

In one embodiment all available products are stored in a product database, e.g. as a hierarchical structure of products or in any other suitable way, where each product may be identified e.g. by a suitable product code. Furthermore, each product stored in the database may have associated with it a corresponding cost structure indicative of the operational costs associated with each product. For example, the costs may be stored by associating a cost structure to each of the legs of a route.

Furthermore, tariff retrieval is based on the defined products from the product database for the identification of locations, ports, transport modes, etc for a selected transport to be the basis for many inputs to the price.

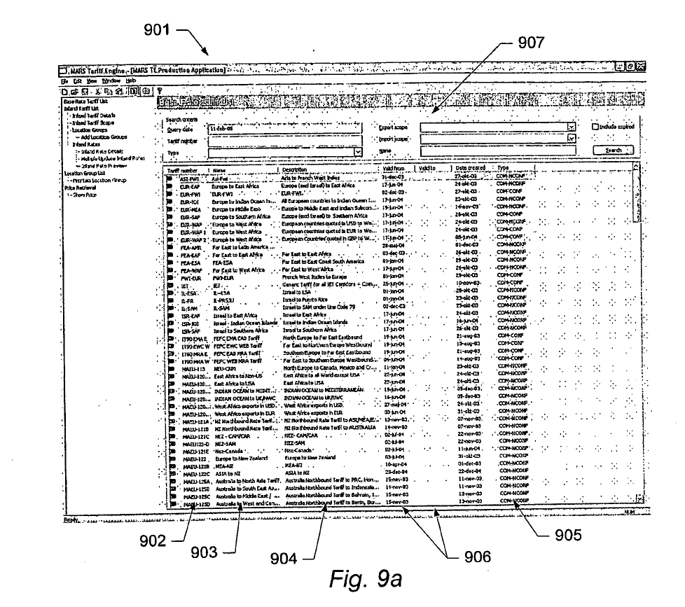

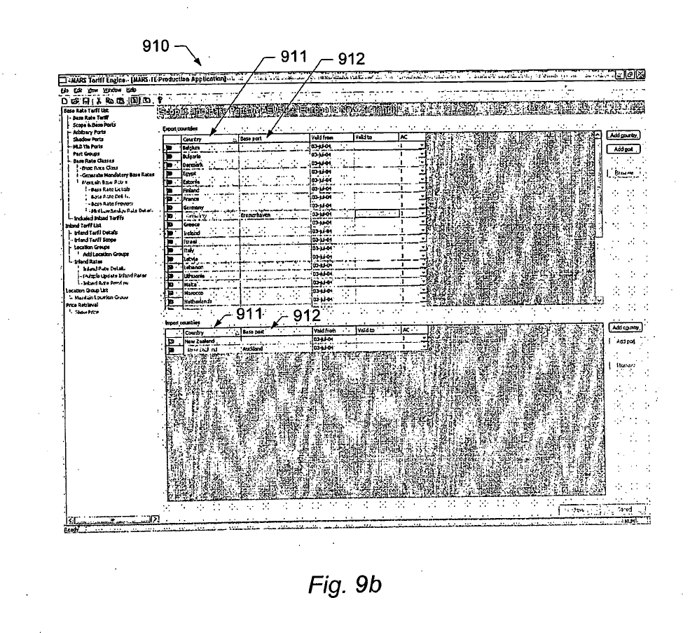

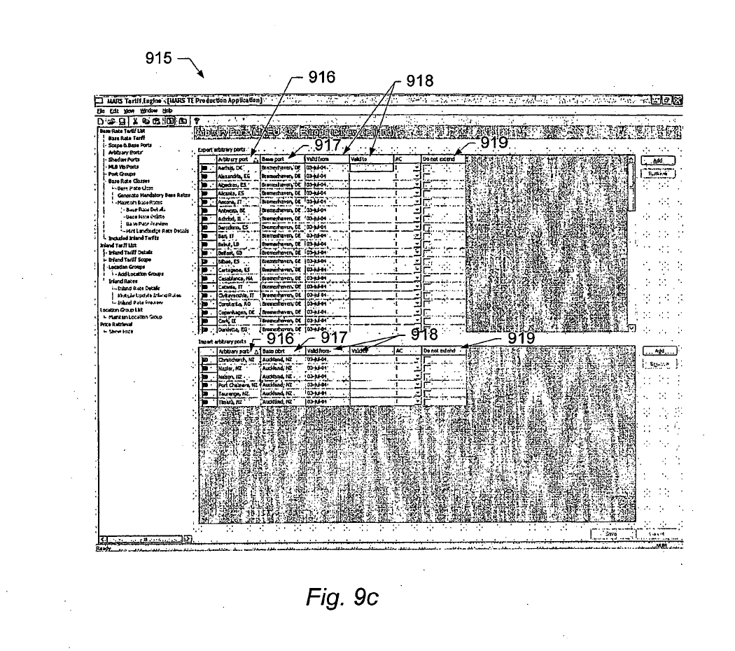

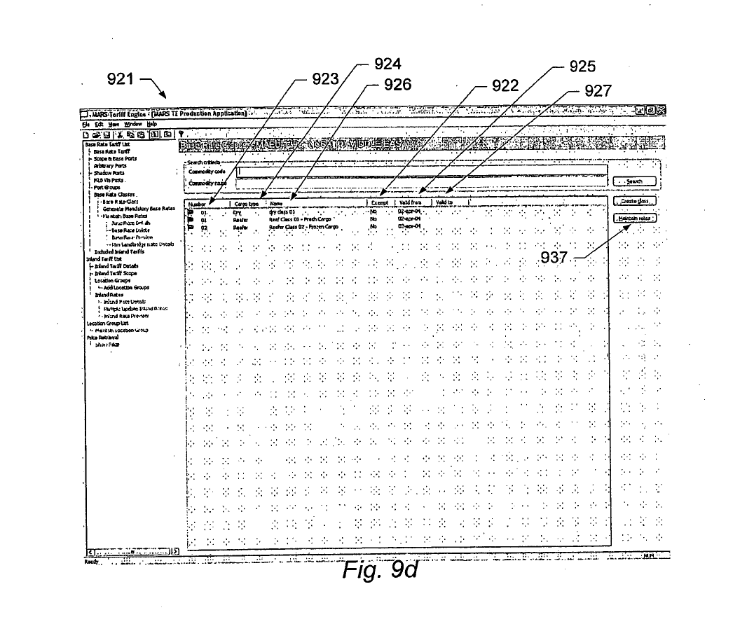

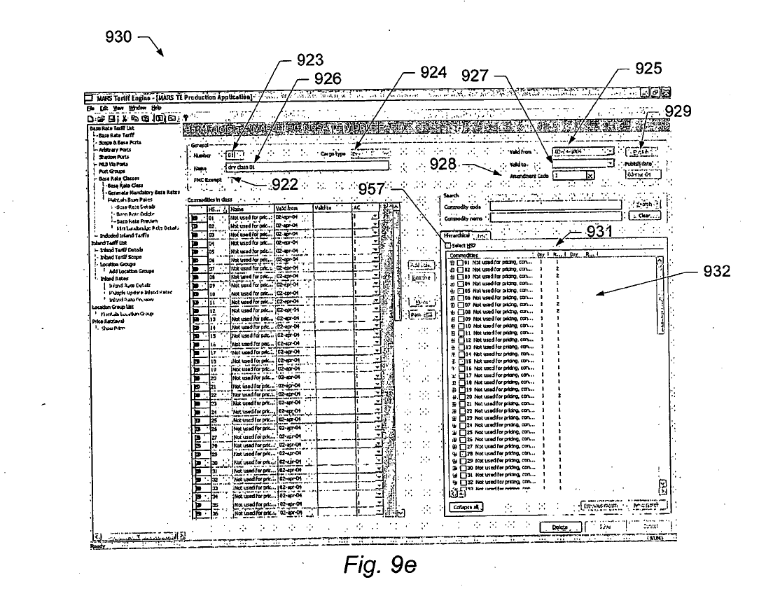

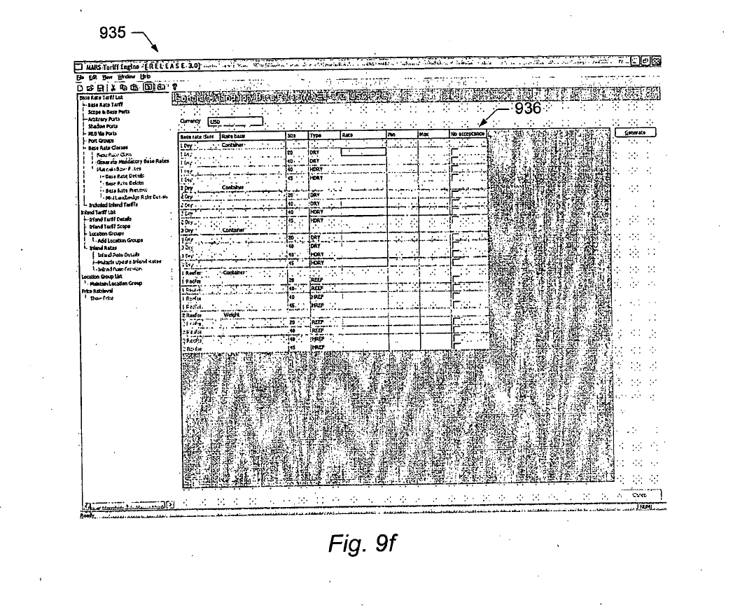

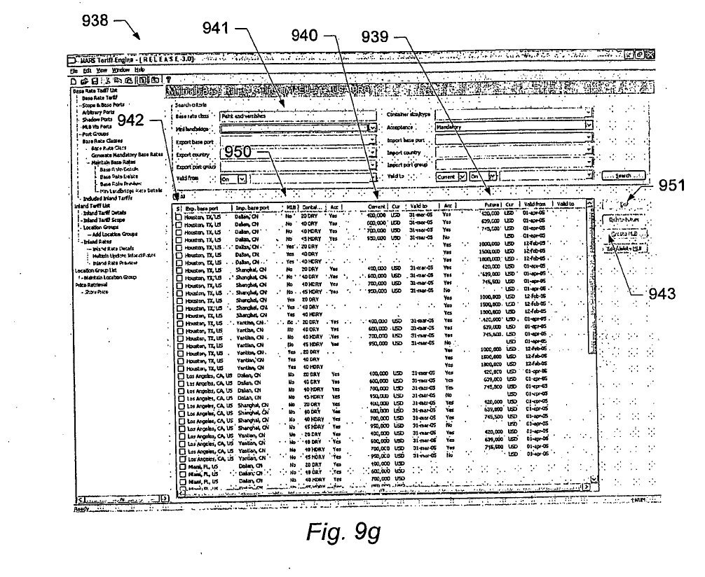

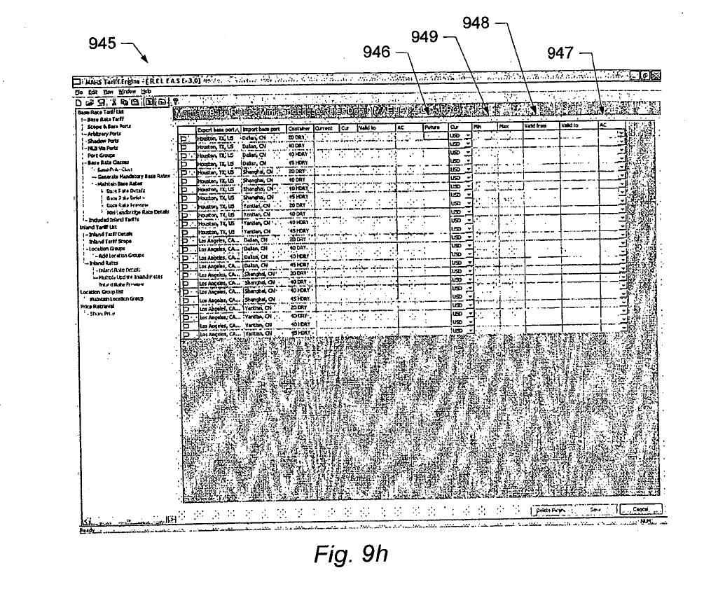

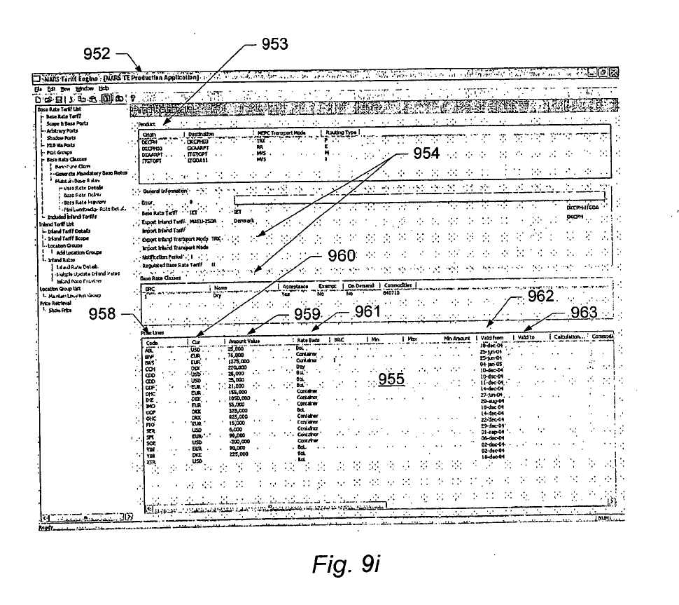

In the following, the creation and maintenance of tariffs by an embodiment of a rating system will be described with reference to FIG. 9.

FIG. 9 shows examples of user-interfaces of a tariff module.

As mentioned above, the Tariff module includes a repository for walk-in rates including base rates by commodity-based base rate classes, links to mandatory and optional (VAS) surcharges (including ‘arbitrary surcharges’ related to arbitrary ports), and inland rates. The MARS Tariff module includes maintenance user-interfaces/screens for base rate and inland tariffs, location groups and their related scopes, commodity classes, and prices. The Tariff module may further include a screen for performing tariff retrieval, e.g. for testing purposes. The Tariff module stores base and inland tariff data in a structured way so that, when combined with the Service Contract and Retrieval modules, complete and accurate price lines can be returned to GCSS, E-rate or another requesting module.

A Base Rate Tariff (BRT) is a price list for transports performed between defined base ports. BRT's are differentiated from one another by their scopes, the list of countries and base and other pricing ports between which base rates are defined. Base Rates and may cover pure ocean transports or ocean-land combined moves, depending on the assignment of base ports.

A BRT holds base rates and links to text and surcharge rules and inland tariffs. The links to surcharges, rules, and inlands from a BRT are made by including/associating rules and inland tariffs in/with a BRT.

The process of creating a BRT may be initiated by a user invoking a Base Rate Tariff List screen as shown in FIG. 9a provided by the tariff module. In the Tariff module, many BRT's may be created to allow for a clear division of maintenance based on operator and tradelane. The Base Rate Tariff List 901 gives an overview of all. Base rate tariffs and provides access to screens for modifying existing Base rate tariffs and/or creating a new Base rate tariff. All BRT's have certain identifying and controlling parameters that are assigned by the user upon creation, e.g. a tariff number 902 and name 903, an optional text description 904, the operator, type 905, currency, validity dates 906, amendment code, and notification period, and/or the like. The base rate tariff list screen further provides search/filter functionality 907 for limiting the displayed list to BRTs that fulfil certain criteria.

The “operator” parameter defines the company for which the base rates are applicable, e.g. in cases where different routes or parts of routes may be operated by different entities. A request for a tariff may thus indicate the operator for the shipment in its price request to MARS, and the retrieval may then limit the rate search to match the specified operator.

In the process of price retrieval, MARS searches through many tariffs to find an applicable BRT for a given rate request. Because military and commercial tariffs may have overlapping scopes, the BRT Type was introduced to allow the Tariff module Retrieval to identify a single applicable BRT. Every BRT is assigned a BRT Type, which is a combination of military/commercial and conference/non-conference attributes.

A currency is assigned when BRT is created and serves as the default currency for all base rates.

“Valid from” and “Valid to”: A BRT has an overall date validity range, meaning the date from which any rates within it may start and end. In one embodiment, “Valid from” date is mandatory, and may not be in the past, while “Valid to” date is optional. The validity period on the BRT allows for the control of applicability of the entire set of rates, and would typically not have a valid to date, unless inland service to the area is being terminated, or a new BRT will replace the existing one.

The Notification period is assigned upon creation of a BRT and enforces a minimum number of days before which a tariff change with direct or potential impact to increase a rate may take place. If notification period is set to 5, it is not possible to make any change take place in less than five calendar days that has the potential effect of increasing a price. In this example, a user attempting to increase to a base rate on January 15 would not be able to save the rate with a valid from date before January 20.

A BRT is created in so-called draft mode. In draft mode the BRT is only accessible in the MARS maintenance screens. This gives time to create and populate a BRT before its rates may be retrieved. Once the BRT is completed, to make it available for retrieval, it must be published. The Publish function does not necessarily transmit the tariff in any form to any external recipient. Publication verifies that the notification period defined in the BRT has been respected. If the valid from date of the BRT does not respect the defined notification period, it is adjusted to current date plus the number of days in the notification period. Any valid-from date of any components of the BRT not respecting notification date is set to the BRT's new notification date. The publication date is set (date of executing ‘publish’) and the BRT becomes available for retrieval.

Special regulations apply to tariffs covering cargo loading or discharging in United States ports. Such tariffs are regulated by the Federal Maritime Commission (FMC). Using checkbox to mark a BRT as FMC-regulated allows functionality for exempt base rate classes, as well as serves to mark rates as FMC-regulated for the Service Contract module.

Once a BRT is created, its base port scope is entered into the Tariff module in the Scopes and Base Ports screen 910 illustrated in FIG. 9b. Base port scope includes countries 911 and base ports 912 on both export and import side of the BRT. All countries from which cargo will originate or terminate are in a BRT's scope, even if no base ports are operated in the country. For example, if a BRT is to hold rates for shipments to Hungary, the country is in the BRT's import scope, even though there are no base ports in Hungary and Bremerhaven serves as Hungary's base port. In this example, Hungary is added without any corresponding Base port. In the configuration of arbitrary ports and inlands the connection of base rates to Bremerhaven with locations in Hungary may be detailed.

At the time of creation of rates, only ports added as base ports will have their own rates. The Tariff module will generate base rates for all combinations of import and export base ports in a BRT.

Base rates hold the prices between base port combinations, but fixed price spreads over the base rates may be maintained by assigning arbitrary ports to a BRT. Arbitrary ports are used when arbitrary surcharges are charged to move cargo from base ports to arbitrary ports. Arbitrary ports may be any CY (“container yard”) location. The fixed additional prices from base ports to arbitraries are handled in MARS as surcharges and set up in the Rules module.

The arbitrary ports and related base ports are added in an Arbitrary Ports screen 915 illustrated in FIG. 9c, before it is possible to record the arbitrary surcharge values in the Rules module.

In one embodiment, arbitrary ports in a BRT may only exist for the countries already in the BRT scope. Each arbitrary port 916 defines which base port's 917 base rates are to be used along with the arbitrary surcharge. An arbitrary port may have more than one price, e.g. it is possible to establish an arbitrary price to Zeebrugge via Rotterdam and another arbitrary price to Zeebrugge via Antwerp. In this example, Zeebrugge is added twice to the arbitrary scope screens, once with each corresponding base port.

In one embodiment the system enforces that the validity dates 918 of an arbitrary do not only fall within the BRT's validity range, but also do not exceed the validity of the country of the arbitrary, or the associated base port or it's country.

“Do Not Extend” Flag 919: It is possible to limit the use of arbitrary ports to control whether inland haulage rates may be combined with an arbitrary port rate. It may be necessary, for example, to limit the use of an arbitrary port such as Madrid to only be a CY delivery location. By marking Madrid via Valencia as an arbitrary port with the “Do not extend” flag, the Tariff module will only use the Madrid arbitrary surcharge for a product ending at Madrid CY and will not use the arbitrary combined with an inland rate for delivery to a storedoor location beyond the Madrid CY. If a storedoor rate was requested, the Tariff module would instead look for a base port and a connecting inland to the storedoor, or another arbitrary to Madrid via another base port which is not marked “do not extend”.

By default, the “Do not extend” flag is not marked and the Tariff module will use a combination of base port, arbitrary, and inland to construct a rate to a′ storedoor when requested. In one embodiment, it is not possible to remove a “do not extend” flag from an arbitrary. To change the “do not extend” flag, the arbitrary must be expired and a new one created with the desired flag value. When changing the “do not extend” status for an arbitrary port, there may be implications for leaving gaps in land rate coverage for the BRT, and inland tariff scopes may need to be adjusted to ensure continuity of coverage.

Shadow ports are a concept used when no BRT base or arbitrary port is found on the MEPC product database. In this case, tariff retrieval cannot proceed. In the rare cases that ports on the MEPC product do not directly correspond to the pricing basis, a Shadow Port may be defined for a BRT to translate the inputs from the MEPC Product. For example, many inland locations in South China (PRC) are priced via Hong Kong but in reality move via other ports, e.g. Yantian. Hong Kong is not in fact a base port for PRC in MARS, because it does not exist within the country PRC. In order to apply the base rates for Hong Kong in when MEPC products use Yantian and Hong Kong is never found in the product, a shadow port is created.

Shadow ports do not have their own base rates. They only serve as pointers in MARS price retrieval to use rates for another base ports in place of a designated port found on the MEPC product. Shadow ports are created in a Shadow Ports Screen provided by the tariff module. Each shadow port is specified for a country, and refers to a base port for which base rates will be used when a product is identified that matches country and shadow port for that BRT during the effective dates. A shadow port may not already be an arbitrary port or a base port in a given BRT. More than one shadow port may point to the same base port in a given BRT but the same shadow port may only point to one base port within that BRT.

Certain trades have traditionally used mini-landbridge (MLB) rates, which are single base rates for transports from an export base port to an import base port that include an overland portion via a third base port. The shipment is not priced as an inland but as a second MLB base rate for the combined overland-ocean ocean shipment. An example is a single base rate covering a shipment from Shanghai, PRC to Charleston, USA but moving via Los Angeles. The MLB rate includes the inland portion between Los Angeles and Charleston, which are both base ports in the BRT, and does not use an inland price in combination with the base rate. Note that an MLB rate is generally a complement to an all-water rate, which has a different market price. MLB via ports are used; when MLB service is offered. If no MLB via ports are defined in the tariff system, MARS will apply a traditional ‘all-water’ base rate, even if an MLB product has been performed.

To establish MLB rates in the Tariff module module, MLB via ports are first established in an MLB Via Ports screen provided by the tariff module. In one embodiment, this functionality is only available with BRT's that have the United States or Canada in Scope. The base ports in the BRT which are allowed to be used as MLB via ports are specified in this screen. Note, these are not the destination ports, but via ports. The MLB base rates apply from the export base port to the import base port, e.g. Shanghai-Charleston in the example, not to the MLB via port (Shanghai-Los Angeles). MLB via ports function on either export or import scope of a BRT, but not both.

Adding and removing MLB via ports is subject to the BRT's notification period, since it may have a direct impact on making new MLB rates available or on expiring existing MLB rates. When MLB via ports are added, corresponding MLB base rates are added.

In the example above, Los Angeles (not Charleston) would be added as an allowed MLB port, since it is the via port. This allows the BRT to control which via ports will qualify for the MLB rates, i.e., if Oakland is not an allowed MLB via port, a move from Shanghai to Charleston via Oakland will not trigger an MLB rate from the Tariff module.

In one embodiment, an MLB rate between two base ports is always the same regardless of what via port is used; it is only a matter of whether the via port is allowed that enables the MLB rate to be used. If an MEPC product shows an MLB move but the via port is not included in the allowed via ports in the BRT, the all-water price for the same base port pair will be retrieved.

Port Groups: Base Rate port groups may be defined in the Tariff module as a means to ease the manipulation of data and to quickly filter long lists of prices in maintenance screens. However, rates are typically not created for port groups, but only for base port-pair combinations.

Port group definitions in the Tariff module are unique to the BRT; they are not shared across tariffs. Port groups include base ports and they are defined in a Port Groups screen provided by the tariff module. A code, a name, and the included base ports are specified for each port group. A base port may only be included in one port'group. Port groups do not have validity dates since they do not affect rates.

Commodity Classes: Base rates in the Tariff module are set against groupings of commodities called Base Rate Classes, and typically not against individual commodities. A base rate class may contain one or many commodities and are established either for dry or reefer cargo. Base Rate Classes that are created in a BRT are listed in the Base Rate Classes screen 921 illustrated in FIG. 9d provided by the tariff module. From that screen it is possible to search for a class containing specific commodities or to create new classes.

Trades that do not use commodities as a price factor still need to use base rate classes but may include all commodities in a single base rate class—one for dry cargo and one for reefer cargo.

Commodity groups as defined in base rate classes are unique to each BRT, i.e. a base rate class in one BRT is typically not used by another BRT. When the number of commodity groups is kept small, tariff maintenance is reduced. The rates in each class are maintained separately, so minimizing the number of classes reduces time and effort for updating base rates.

Special classes may be needed to house certain commodities that are exempt from FMC regulations in an otherwise FMC-regulated BRT. When creating a base rate class, the “FMC exempt” box 922 can be checked. The commodities included in the class will have a notification period of one day, regardless of the notification period of the BRT. Rates for exempt commodity classes are also not retrievable by self-service of other external portals. The commodities can be expired or moved to another class if the FMC regulatory status changes.

Base rate classes, like base rate tariffs, are created in draft mode and are only retrievable once published in order to allow a period when a new class can be set up and completed before affecting rates. Creation and expiration of classes and movement of commodities between classes is subject to notification periods, since rate increases may result.

The Base Rate Class screen 930 illustrated in FIG. 9e shows an individual defined base rate class and allows adding and/or editing and/or deleting base rate classes. A base rate class has a number of attributes associated with it: A number 923, a Cargo type 924 (dry or reefer), a valid from date 925, an amendment code 928, an optional Class name 926 and an optional valid-to date 927. Before a class can become activated, it is assigned a publish date 929 if it was not automatically published with the publication of the BRT.

The Tariff module uses a commodity tree to identify commodities. The commodity tree is based on a hierarchy with a top-level commodity code “00”, second-level four-digit commodity codes, and third-level six-digit codes. Each six-digit commodity has a parent four-digit commodity, and each four-digit commodity's parent is the top-level commodity “00”.

When a base rate class is created, its commodity contents may be defined. Maintenance of base rate class commodities is handled in the Base Rate Class screen, the same screen used for creation.

the Tariff module also uses the commodity tree hierarchy in the retrieval of rates. For example, including top level ‘00’ in a base rate class will cover all four- and six-digit commodities when not present in other classes. MARS will find the most specific commodity match to the input on the rate request to determine the applicable base rate class. In the absence of a six-digit match, the parent four-digit commodity is used, and if no four-digit commodity exists then the rate class containing the mandatory top-level commodity is used. The four columns 931 titled Dry and Reefer in the commodity hierarchical and list view 932 display which current and future class each commodity is included in. A black number indicates an explicit inclusion whereas a gray number indicates that the commodity is included by extension of the hierarchy.

In one embodiment, the Tariff module requires that the top-level commodity is included in exactly one dry and one reefer base class in each base rate tariff so that in principal there are rates for all commodities. For trades which do not use commodity as a price factor, a single dry and a single reefer class may be created and checking the ‘Select HS2’ box 957 causes all the top-level commodities to be included.

Base rates are established between all base port pairs in a BRT. To facilitate this, the Tariff module has a base rate generation feature 935 as illustrated in FIG. 9f that creates base rates for all port pairs at levels specified per commodity class. Base rates are generated at the same rate for every base port pair for each container size/type combination in a given base rate class. In trades where base rates for base port pairs are not uniform, generation at common rates is still required, and the bases rates must then be edited to the desired rate. Base rates are generated for all base port combinations for both current and future periods, unless the base rates are marked “no acceptance” or “on demand”. These may then be edited if base rates are not uniform across all base port combinations. In one embodiment, generation is the only way to create base rates in the Tariff module. If the scope of a base rate tariff is modified to add new base ports, base rates are generated again to create base rates for the additional base port pairs.

The tariff module includes a number of screens for maintaining base rate tariffs, an example of which is shown in FIG. 9g. For base rates, the Tariff module includes up to two versions or time periods in the maintenance screens, i.e. current rates and future rates. Historic rates are retained in the database but are not maintainable, so they are not visible on the Tariff maintenance screens.

The Maintain Base Rates screen 938 lists all base rates for a given class and allows search for specific rates for maintenance purposes. Once the searched base rates are selected, future rates may be edited or deleted, MLB rates may be created and future MLB rates edited, or deleted.

All rates in MARS are created with at minimum one day's notice. This means no rate is created and effective the same day. Therefore, all new rates are created as future rates and appear in the ‘Future’ columns 939 in MARS screens. Upon becoming valid, the future rates become current rates and are displayed as such in a current column 940, leaving room in the future column for adjustments to future rates again.

Base rates in the Tariff module are container rates. The present embodiment of the Tariff module does not handle LCL or breakbulk cargo, even though it will be appreciated that other embodiments may do so. Base rates are set for eight container size/type combinations: four dry (20′, 40′, 40′HDRY, 45′HDRY) and four reefer (20′, 40′, 40′HREF, 45′HREF). Prices for other equipment types are handled as surcharges and the appropriate special equipment charges set up. Base rates can be specified using differing rate basis (per container, per ton, per package), but the same rate basis applies to all rates in a given base rate class.

Once all commodity classes are created it is possible to mass create the base rates for the port-pair combinations for all classes from the Generate Mandatory Base Rates screen 935. As indicated, the screen generates the mandatory base rates, not optional rates such as MLB base rates.

It is possible to make exceptions to not generate specific size/type/cargo combinations by base rate class using the ‘No Acceptance’ flag 936. The no-acceptance flag can be set for individual container/cargo size/type combinations at the time of generation of the base rates. If an acceptance later changes, the rates may be modified to remove the flag and establish prices. Also, individual base rates may be updated from standard base rates to ‘no acceptance’ if needed.

It is possible to use an ‘on-demand’ flag to remove a base rate. In price retrieval, the user gets a message that the requested rate is ‘on demand’. When/if it is desired to publish a short-term base rate for the on demand, a price can be added with an expiration date. Once the valid-to date is reached, the base rate will expire and return to on-demand and blank again. It is possible to edit and remove the on-demand flag entirely such that the base rate is treated normally and has an indefinite future (mandatory) rate as well.

Once mandatory rates are generated, optional MLB base rates may be created. MLB base rates are created if the tariff scope provides for MLB via ports and there are MLB products in the tradelane. The base rates are accessed via the base rate class list screen 921 by activating a Maintain Rates button 937 which invokes the Maintain base Rates screen 938. Just as rates were generated with potentially different levels and rate bases for each commodity class, MLB rates are created for each class.

MLB rates are established for a selected port pair. The user may use the search filters 941 to limit the list by import/export country, port group, base port, etc. The user may then select the rate lines which need MLB rates by checking the corresponding box 942 at left and press the Create MLB button 943 to move to the Mini Landbridge Rate Details screen 945, illustrated in FIG. 9h.

The lines selected are presented on the Mini Landbridge Rate Details screen with an editable future rate field 946 for each, as well as a minimum/maximum 949 if the rates basis is other than container. An amendment code 947 and valid-from date 948 are included. After Saving the rates and return to the Maintain base rates screen, the rates are displayed and marked YES in the MLB column 950.

Once mandatory rates are generated, future rates may be edited. Only future rates may be modified. The rate value, currency, rate basis, minimum/maximum (if applicable), the validity dates, non-acceptance and on-demand flags may be changed. A future rate may also be deleted, leaving the current rate effective indefinitely. A user may access the base rates by entering the Base Rate Classes screen via the navigation tree to select the class for which rates are to be modified.

The user may highlight the class to be updated and press the Maintain Rates button 937 to move the Maintain Base Rates screen 938. The user may then identify base rates that need to be modified, e.g. by using the search filters to limit the list by import/export country, port group, base port, etc. It possible to select multiple container size/types but Mini-landbridge rates cannot be edited at the same time as all-water rates. The user may select the rate lines to edit by checking the box 942 at left and press the Edit button 951 to move to a Maintain Base Rates-Modify Future Versions screen. The currency and future rate may be changed to a specific value, adjusted up or down by a fixed amount or percentage. An amendment code will default and can be modified. The minimum/maximum fields are editable for certain all rate bases except “container”. The no-acceptance and on-demand flags may be edited as well. The validity of the change is set in a “valid from” box, applying to each rate line.

The requested changes may be displayed in a preview screen along with any conflicts or illegal changes due to notification requirements. It is also possible to print the changes for external review. If no conflicts exist, the changes may be saved. Deletion of future rates may be performed using corresponding screens and principles.

In an embodiment of the rating system, tariff rules are not created from within an individual BRT. Instead, all BRT's make use of rules that exist outside of tariffs—in the Rules module—so that all tariffs refer to the same rules definitions and methods of calculation. This ensures a high degree of uniformity of structure and reuse of data in MARS. Surcharges are one type of rules that are handled in the Rules module application. Rules are described in greater detail below.

Base rate tariffs are stand-alone entities and until they are connected to independent inland tariffs it is not possible to retrieve inland rates in combination with the base rates. In order for the rates in an Inland Tariff to be combined with ocean rates from a base rate tariff, the Inland Tariff are included in/associated with the Base Rate Tariff.

Inland tariff may be configured in different ways, meaning that they may contain inland rates from water port or inland CY locations. In one embodiment, only Inland Tariffs with scope countries matching the scope countries of the Base Rate Tariff can be included. Furthermore, in one embodiment, for inland rates to be retrievable in combination with a base rates, the BRT's base port or arbitrary port must be the same as the inland tariffs ‘inland port’.

Inclusion of inland tariffs is performed in a corresponding Included Inland Tariffs screen provided by the tariff module. An Inland Tariff is included in a Base Rate Tariff either as an export Inland Tariff or an import Inland Tariff, although the Inland Tariff itself may include prices for both inbound and outbound transports. Inclusion in the Base Rate Tariff has a validity period, with a valid from and optional valid to date. A Base Rate Tariff may contain more than one Inland Tariff for a single country, e.g. for different Inland Ports.

For example, a Base Rate Tariff for Canada to France may include two French Inland Tariffs, but one has LeHavre as pricing port and the other has Fos sur Mer. In one embodiment, the Tariff module will not allow the inclusion where an overlap can exist.

As stand-alone entities themselves, inland tariffs have their own validity dates, etc. But, with reference to notification periods, changes to an inland tariff respect the notification periods of the base rate tariffs they are included in. Therefore, if a BRT with one-day notification includes a given inland tariff, and the same inland tariff is included in a second BRT with 30-day notification period, certain changes in that inland tariff respect the greatest notification period, i.e. 30 days.

Locations are the smallest building block of inland rates in MARS. Locations in MARS are defined by a geographic database service and/or other systems. A Location Group is a set of inland locations which share the same price. Location groups are stand-alone entities in MARS, and independent of inland tariffs. They are created once and can be used many times in a single inland tariff, or in several different inland tariffs. Inland prices in MARS are set between Inland Ports and Location Groups. A Location Group may contain only one location, or many locations. Since rates are set on location groups, the potential for a location group to contain many locations means reduced maintenance of inland rates in MARS.

Location Groups may be defined to meet the needs of the inland price market, whether that represents a basis of distance, postal codes, or other factors. MARS does not determine what the contents of a location group should be, but only holds the definition of the group, i.e., the locations it contains.

Inland Location Groups are created with a name and description. MARS assigns a number to the location group upon creation. A location group has a validity period, or at least a valid-from date. A location group is created for a specific country, and it contains locations within that country.

Once created, any existing location in the specified country may be added to the location group. Locations may be created in the GEO module described above and made available in MARS. The included locations have their own validity period, which means they can move in and out of a location group as needed.

Location groups can be created to handle two different kinds of inland pricings. When pricing is done explicitly by distance ranges from a given port, the location groups form concentric circles around the port. Each location in a distance range has the same inland price. In this case, the rings only have relevance with reference to the port at the center. It is possible in MARS to create location groups only for use with a specific inland port—called a Focal point. In another inland pricing model, locations are priced by their presence in a generic zone, e.g. a zip code, postal zone, country, or other administrative area. In this case, there is no need to create location groups with reference to any single port, since they can be used with many ports, having different prices to each. In this scenario, no focal point is used, allowing the location groups to be reused with many inland ports.

The start and end points of an inland tariffs rates depend on its geographic scope, but all tariffs have certain identifying and controlling parameters that are assigned by the user upon creation. Most basic is the tariff number and name, an optional text description, a direction, and an operator.

The “direction” specifies whether the rates in a given Inland Tariff are applicable for import shipments or export shipments. The direction can be “export”, “import”, or “both”. If inland rates for a given operator and country are valid for both inbound and outbound shipments, a single Inland Tariff with direction “both” can be maintained. If rates for a given carrier and scope differ based on whether the shipment is inbound or outbound, then two Inland Tariffs are maintained, one with direction “export” and one with “import”.

An inland tariff may be set up to hold inland rates scaled by weight intervals. The number of intervals are set at the time of tariff creation in a Tariff Details screen. Upon saving, a grid is generated based on the number of intervals requested and the maximum cargo weight for each weight interval can be set for each container size and cargo type combination. The top interval may be open-ended or may have a maximum weight, which will mean that weight above that figure will not have an inland price.

An Inland Tariff has a “scope” consisting of the countries and Inland Ports. An Inland. Tariff contains prices for transports within at least one country. A country is added to the scope of an Inland Tariff in order to later hold rates to or from any location in that country. The same country may be in the scope of more than one Inland Tariff, i.e. part of a country's inland area may be covered in one Inland Tariff and another part in another Inland Tariff. Rates in an Inland Tariff cover a transport from one point to another. One end of the transport connects to the ocean shipment at a base port or arbitrary port and the other end is an inland location. Every country added to an inland tariffs scope has an “inland port”.

Once a BRT is published, rates can be retrieved and tested. To this end a Price Retrieval screen is available in the MARS tariff module so as to allow tariff maintenance users to simulate tariff retrieval. In general, price retrieval will be performed from, other modules of the rating system or external modules as described herein.

To retrieve the price for a shipping product, the request includes a number of parameters, which may for example be entered by a user via a price retrieval screen: Receipt and delivery locations, e.g. specified by a five-digit codes (e.g. HKHKG for Hong Kong), optionally the MEPC main load/discharge ports if a price for a specific product is to be retrieved, operator, container size, type, cargo type, weight, military or commercial tariff, and origin and destination service mode, Commodity by its code, and/or the like.

There are a number of optional input parameters for a price retrieval request: One or more reefer, equipment and dangerous characteristics can be specified by using their codes.

When the tariff module receives a price retrieval request, e.g. when a user has pressed a “retrieve price” button to initiate the rate retrieval, the tariff module identifies an appropriate BRT. If MARS finds more than one BRT of different types, the user may be prompted to specify if the user wants the retrieval to use a conference or non-conference BRT.

MARS returns the result of the search to the requesting module or in a Show Price screen. If the retrieval fails, e.g. because no product corresponding to the search criteria is found the electronic product catalogue database, an error message is returned.

FIG. 9i shows an example of a results screen 952 showing the result of a price retrieval. The screen shows the details of a found product at the top of the screen as indicated by reference numeral 953. Each link of the transport route is displayed along with its transport mode and other details. The middle portion 954 of the screen displays the details of how and where the rate was retrieved. The BRT, the base ports, the base rate class used and specifically which commodities were matched are displayed. The export and/or import inland tariffs along with the inland port and inland transport mode of the inland rates is displayed. Details about the notification period, and FMC status of the BRT, the acceptance/on demand and/or exempt status of the base rate are also displayed.

In the bottom panel 955 the price lines are displayed. There is one line for each applicable pricing element 958: A base rate and potentially and import or export arbitrary, and import or export inland, and a line for each surcharge is displayed with its price 959, currency 960, rate basis 961, valid-from (962) and optionally valid-to date 963. In a Name column, the name corresponding to the freight code may be displayed as well as whether the price line is from a BRT, or and export (EIT) or import inland tariff (IIT).

In the price lines grid, for the base rate and each surcharge which was triggered by a base rate class parameter, the base rate class number 964 used is displayed.

One column may indicate any lines that were triggered because of a dangerous characteristic and the value matched. There are six columns for Location—these display up to six location-based parameters that triggered the application of the price line. In this way it is possible to see that a given surcharge was applied because one of the geographic locations in the pricing product (base port, arbitrary port, origin/destination country, state, etc.) matched a surcharge parameter value.

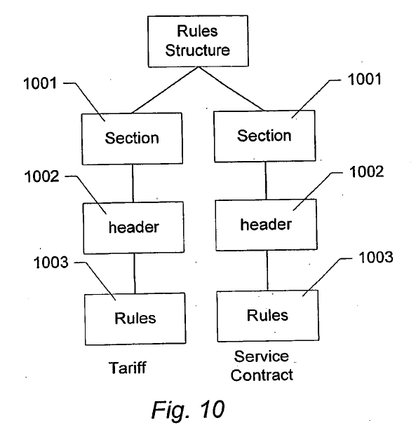

FIG. 10 illustrates a data structure for storing rules. The Rules module is constructed to hold rules of different types and for different uses, such as rules of type Text, Calculable, and/or Surcharge.

Text rules are pure text blocks and serve as the text terms of service contracts or textual rules of tariffs and may have data references. For instance a mixed commodity rule describing the pricing of mixed commodities is a pure text description. In some situations a text rule can refer to tariff or service contract data, for instance scope rules referring to country scope and base ports are commonly used in tariffs as well as service contracts. The reference from a text rule to tariff or service contract data is not used for any calculation of charges or product price.

Calculable rules hold text and values to be able to record and report, and potentially for use in calculation, such as free days, minimum quantity commitment, VIP discounts, etc. Calculable rules may be regarded as rules that describe a calculation of a charge to be used by external systems. A common example is credit days. Typically, some of the rule information related to a calculable rule cannot be specified independently of the context the rule is in. For instance the number of credit days can vary from tariff to tariff or even from country to country in a tariff. Likewise for service contract terms. The actual number of credit days is therefore not specified in the rule but is specified per tariff and/or country. Another example of a calculable rule is MQC (Minimum Quantity Commitment) in a service contract.

Surcharge rules hold text and detailed calculation instructions and parameters needed to calculate tariff additional. Surcharge rules are typically used only in tariffs for specifying charges to be returned by the product price retrieval when requesting the price of a product. Surcharge rules specify applicable surcharges such as terminal handling charge, arbitrary charge, etc. and value added service charges such as the charge for police escort and fumigation.

The organizational hierarchy of rules may include different levels, e.g. Sections 1001, Headers 1002, and Rules 1003. Sections may be thought of as ‘binders’ or holder of similar types of rules. Under section falls Headers. Headers hold the common name, high-level definition, and code for a rule. Rules themselves carry their header's information plus more information making each one different. For example, in a Section called Documentation Surcharges, a Header called Extra OBL Fee—contains many Rules for applying the charge for additional originals viz. one as a lump sum amount per booking, another as per B/L original charge with the amount varying per customer segment, and a third as 100% surcharge on the standard documentation fee.

Tariff rules and service contract rules are separated in the Rules module and are not shared between service contract and tariffs. Some users will have access to maintain service contract sections and the rules inside those sections but will not necessarily have access to maintain tariff sections and visa versa. In the Rules module separate functionality is provided for maintaining tariff rules and service contract rules.

Sections, Headers, and Rules are non-versioned entities, i.e. have no validity period attached. The rules are available for inclusion into a tariff/service contract as soon as they are created.

Rules in the Tariff module are marked as Centralized or Decentralized. Surcharge rules that are created as centralized are created with rates, and any tariff that includes the surcharge takes the rates along with the rule. A decentralized rule is created as the structure to calculate a surcharge, but no rates are included, so each tariff upon inclusion must add it own values to the calculation. Centralized rules are advantageous for surcharges whose rates do not vary by trade. Decentralized rules allow a common definition and calculation to be set up once, and many tariffs may use the rule but customize the prices to their own trade.

Surcharge rules in MARS are marked as being for value-added services (VAS) or not. This distinction is useful for the retrieval of surcharges. VAS surcharges are optional and are not returned to on retrieval unless they are requested on the input. Surcharges that are not marked VAS are mandatory and are returned for every applicable rate. Price Retrieval shows all charges irrespective Optional or Mandatory charge, where as Rate Lookup has an option to filter VAS and can limit display of list of surcharges applicable. For example, a CAF surcharge rules included in a tariff will apply, only when every parameter in it is met whereas a Container Cleaning Fee will only be applied if it is requested on the rate request to MARS. It is possible to override the default VAS flag to make a normally-optional charge to mandatory in a certain tariff.

Although some embodiments have been described and shown in detail, the invention is not restricted to them, but may also be embodied in other ways within the scope of the subject matter defined in the following claims.

Embodiments of the method described herein can be implemented by means of hardware comprising-several distinct elements, and by means of a suitably programmed microprocessor. In the device claims enumerating several means, several of these means can be embodied by one and the same item of hardware, e.g. a suitably programmed microprocessor, one or more digital signal processor, or the like. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A computer-implemented method of generating a service contract for a shipping product, the method comprising:
receiving information indicative of a requested shipping product;
verifying an availability of the requested shipping product by means of an electronic product catalogue;
receiving a tariff corresponding to the requested shipping product from a tariff system;
receiving cost information about a cost of the requested shipping product from the electronic product catalogue;
providing a user interface for allowing an operator to determine a price proposal based on the received tariff and the received cost information;
generating a service contract based on the determined price proposal.

2. A method according to claim 1, wherein the tariff includes a price structure including rates for transport between ports from a predetermined group of ports.

3. A method according to claim 2, wherein the price structure includes rates for at least one group of commodities.

4. A method according to claim 2, wherein the price structure further includes inland rates for land transport between at least one of said ports and an inland location.

5. A method according to claim 2, wherein the price structure further includes a rate for at least one value added service.

6. A method according to claim 1, further comprising storing a plurality of tariffs in a tariff system, storing product information indicative of a plurality of shipping products in an electronic product database, and storing a plurality of service contracts, each service contract being specific for a predetermined group of customers.

7. A method according to claim 1, further comprising storing a plurality of rating rules associable with at least one of a tariff and a service contract, each rule being indicative of a pricing rule for pricing a service associated with the shipping product.

8. A method according to claim 1, further comprising storing a plurality of rating rules associable with at least one of a tariff and a service contract, each rule being indicative of a pricing rule for pricing an inland transport between at least one of said ports and an inland location.

9. A method according to claim 1, further comprising providing rate information about a shipping product to a user, wherein providing rate information to a user comprises:
receiving a user identification of a user by a data processing system;
receiving information indicative of a shipping product;
automatically detecting whether the data processing system has stored a service contract associated to the user and covering the specified product;
responsive to the automatic detection, determining rate information for the shipping product from one of the detected service contract and a tariff retrieved from a tariff system.

10. A method according to claim 1, further comprising storing the service contract as a data structure indicative of a plurality of service contract lines, each service contract line having a status field attached to it indicative of a contractual status of the service contract line.

11. A computer-implemented method for providing rate information about a shipping product, the method comprising:
receiving a user identification of a user by a data processing system;
receiving information indicative of a shipping product;
automatically detecting whether the data processing system has stored a service contract associated to the user and covering the specified product;
responsive to the automatic detection, determining rate information for the shipping product from one of the detected service contract and a tariff provided by a tariff system.

12. A method according to claim 11, wherein the information indicative of a shipping product includes at least one of a receipt location, a delivery location, and a commodity.

13. A method according to claim 11, wherein the tariff includes a price structure including rates for transport between ports from a predetermined group of ports.

14. A method according to claim 13, wherein the price structure includes rates for at least one group of commodities.

15. A method according to claim 13, wherein the price structure further includes inland rates for land transport between at least one of said ports and an inland location.

16. A method according to claim 13, wherein the price structure further includes a rate for at least one value added service.

17. A method according to claim 11, further comprising storing a plurality of tariffs in a tariff system, storing product information indicative of a plurality of shipping products in an electronic product database, and storing a plurality of service contracts, each service contract being specific for a predetermined group of customers.

18. A method according to claim 11, further comprising storing a plurality of rating rules associable with at least one of a tariff and a service contract, each rule being indicative of a pricing rule for pricing a service associated with the shipping product.

19. A method according to claim 11, further comprising storing a plurality of rating rules associable with at least one of a tariff and a service contract, each rule being indicative of a pricing rule for pricing an inland transport between at least one of said ports and an inland location.

20. A method according to claim 11, further comprising storing the service contract as a data structure indicative of a plurality of service contract lines, each service contract line having a status field attached to it indicative of a contractual status of the service contract line.

21. A computer-implemented method of managing a service contract associated to a plurality of shipping products, wherein the method comprises storing the service contract as a data structure indicative of a plurality of service contract lines, each service contract line having a status field attached to it indicative of a contractual status of the service contract line.

22. A method according to claim 21, wherein the status flag is configured to have one of a set of predetermined status values, each status value being indicative to a corresponding step in a predetermined workflow for processing a service contract line.

23. A method according to claim 22, wherein the workflow includes at least the following steps:
preparing a request for a service contract line
processing the request resulting in a price structure based on a stored tariff
evaluating the processed request resulting in a service contract proposal to a customer.

24. A computer program product comprising program code means adapted to cause a data processing system to perform the steps of the method according to any one of claims 1 through 23, when said program code means are executed on the data processing system.

25. A data processing system configured to perform the steps of the method according to any one of claims 1 through 23.

26. A computer-implemented transport rating system comprising an electronic product catalogue for storing information specifying a plurality of shipping products, a tariff system for providing standard tariffs related to shipping products, and a service contract system for generating a customer-specific service contract for a shipping product.

27. A computer-implemented transport rating system according to claim 26, wherein the service contract system includes:
a user interface operable to receive user input indicative of a requested shipping product;
a processing unit operable to verify an availability of the requested shipping product based on information received from the electronic product catalogue;
an interface to the tariff system operable to receive tariff information corresponding to the requested shipping product;
an interface to the electronic product catalogue operable to receive cost information about a cost of the requested shipping product from the electronic product catalogue;
a user interface operable to present a pricing structure determined from the received tariff information and the received cost information to a user and to receive a user input indicative of a change in the pricing structure resulting in a price proposal; wherein the processing unit is further operable to generate a service contract based on the determined price proposal.

28. A computer-implemented system for providing rate information about a shipping product to a user, the system comprising:
an interface operable to receive a customer identification of a customer and information indicative of a shipping product;
a tariff system for storing a plurality of price structures for respective shipping products;
a service contract system for storing a plurality of service contracts, each service contract being associated to at least one specific customer and being related to a plurality of shipping products;
a processing unit operable to automatically detect whether the service contract system has stored therein a service contract associated to the received customer identification and related to the specified product; and wherein the processing unit is operable, responsive to the automatic detection, to determine rate information for the shipping product from one of the detected service contract and a tariff provided by the tariff system.
